(19) United States
(12) Patent Application Publication
(10) Pub. No.: US 2026/0066696 A1
(43) Pub. Date: Mar. 5, 2026

(54) GRID-SCALE NATURAL-LANGUAGE-INTERACTIVE ANALYSIS MONITORING AND CONTROL PLATFORM

(71) Applicant: Utilidata, Inc., Providence, RI (US)

(72) Inventors: Marissa Hummon, Golden, CO (US); Michael James, Northville, MI (US); Taylor Spalt, Sterling, VA (US)

(73) Assignee: Utilidata, Inc., Providence, RI (US)

(21) Appl. No.: 19/013,300

(22) Filed: Jan. 8, 2025

Related U.S. Application Data
(60) Provisional application No. 63/689,031, filed on Aug. 30, 2024.

(51) Int. Cl. H02J 13/00; G05B 13/02

(52) U.S. Cl. CPC H02J 13/12; G05B 13/027

(57) ABSTRACT

The solution provides a system remote from edge devices at sites of an electricity grid. The system can have a processor to trigger, based on a characteristic of electricity related to the electricity distribution grid, a control function. The processor can ping, using a natural language-based protocol compatible with a generative machine learning model, edge devices for data on electricity consumption at the grid and receive, from the edge devices, information having data structures generated via the generative machine learning model executed by the edge devices. The processor can generate, based on the information and a grid layout, responsive to the trigger of the control function, guidance to impact the electricity characteristic at one or more sites. The system can transmit, to the edge devices, the guidance to adjust the electricity characteristic.

### CROSS-REFERENCES TO RELATED APPLICATIONS

This application claims the benefit of priority under 35 U.S.C. § 119 to U.S. Provisional Patent Application No. 63/689,031, filed Aug. 30, 2024, which is hereby incorporated by reference herein in its entirety.

### FIELD OF THE DISCLOSURE

This disclosure relates generally to systems and methods of a natural-language-interactive electric-metering platform, including, for example, grid-scale natural-language-interactive analysis monitoring and control platform.

### BACKGROUND

Utility distribution grids can generate and distribute electric power to various customer sites. The utility distribution grids can supply power via transmission or distribution lines to various loads at the customer sites, such as consumer electric devices or residential charging infrastructures.

### BRIEF SUMMARY OF THE DISCLOSURE

The utility distribution grids can use meters to observe or measure utility delivery or consumption in the grid. These meters, among other components within utility distribution grids, can collect samples of power delivery to or consumption at respective sites (e.g., residential homes, facilities, or entities), such as voltage information, at a sample rate (e.g., one sample every 15 to 60 minutes). Loads may be fed from diverse energy sources, e.g., gasoline, propane, oil, wood, natural gas, or electricity. In some cases, the loads may be unified under a single energy source (e.g., electricity) from the electrification of these loads, which introduces challenges for electric utilities, including support for the increased current flows.

In certain systems, a non-physical approach may be implemented to modulate flexible or controllable loads via pricing to discourage electrical usage at peak times or charging and discharging energy storage at the edge during off-peak times and peak times, respectively. Such approach may involve a tradeoff, including the extended utilization of existing, physical grid infrastructure at the expense of complicating its end-to-end operation. The increase in such complexity may lead to energy distribution inefficiencies and energy losses. For example, the system may face challenges such as accurately predicting peak demand times, managing the increased load on the grid infrastructure, and ensuring real-time data processing and communication between edge devices and the central system. These issues can increase the likelihood of technical difficulties, including energy losses, electricity instability, and power outages due to the inability to balance supply and demand effectively. To address these challenges, the systems and methods of the technical solution can provide the ability to measure power consumption and generation at the grid edge and process the data to assist the consumers as discussed herein.

Grid edge data and control can be beneficial at an edge location, such that edge devices can process the grid edge data locally at a high resolution, reducing network resources from transmitting the grid edge data over the network or improving accuracy in determining or predicting at least the electrical consumption, for example. The grid edge data can be beneficial in the context of larger-scale analysis tasks over the entire grid, or at least a subset of the grid. Such grid edge data can be beneficial to grid operators with limited visibility of fine-grained measurements over the grid that the operators are managing and controlling. Therefore, the systems and methods can support grid-scale data collection, analysis, or control to contribute to the evolution and optimization of the electrical grid, and the synthesis of grid-edge data with grid-scale analysis or objectives. The energy-measurement and data-processing benefits may be grouped into multiple categories, including grid equipment (e.g., utilization, monitoring or forecasting, or wear-and-tear), understanding the usage or other factors that affect reliability and resilience to improve the grid metrics (e.g., energy measurement and data processing), and optimization of flexible or controllable loads and distributed energy resources (DERs).

This disclosure is directed to a system. The system can include a data processing system. The data processing system can include, or be implemented using, one or more processors coupled with memory. The data processing system can be located remote from a plurality of edge devices located at a plurality of sites in an electricity distribution grid. The data processing system can be configured, via one or more instructions stored in memory and processed by one or more processors, to perform various functions. The data processing system can be configured to trigger, based on a characteristic of electricity related to the electricity distribution grid, a control function. The data processing system can be configured to ping, using a natural language-based protocol compatible with a generative machine learning model, the plurality of edge devices for data related to consumption of electricity via the electricity distribution grid. The data processing system can be configured to receive, from the plurality of edge devices, information in response to the ping. The information can include one or more data structures generated via the generative machine learning model executed by each of the plurality of edge devices. The data processing system can be configured to generate, based on the information and a layout of the electricity distribution grid, responsive to the trigger of the control function, guidance configured to impact the characteristic of electricity at the plurality of sites. The data processing system can be configured to transmit, to the plurality of edge devices, the guidance to impact the characteristic of electricity at the plurality of sites.

The data processing system can be configured to detect a peak in demand of electricity on the electricity distribution grid. The data processing system can be configured to trigger, based on the detection of the peak, the control function to flatten the demand. The data processing system can be configured to ping, prior to triggering the control function, the plurality of edge devices for a prediction related to consumption of electricity over a time interval. The data processing system can be configured to detect a peak in demand of electricity during the time interval based on receipt of the prediction responsive to the ping. The data processing system can be configured to trigger the control function responsive to detection of the peak in the demand during the time interval.

The data processing system can be configured to construct, using the natural language-based protocol, a prompt defining a format for the information generated by the plurality of edge devices. The data processing system can be configured to ping the plurality of edge devices using the prompt. The data processing system can be configured to receive the information in accordance with the format defined in the prompt.

The data processing system can be configured to determine, based on the information, to perform a second ping, using the natural language-based protocol, of the plurality of edge devices prior to generation of the guidance. The data processing system can be configured to receive, from the plurality of edge devices, second information responsive to the second ping. The data processing system can be configured to generate the guidance based on the second information.

The data processing system can be configured to generate, based on the information and the layout of the electricity distribution grid, responsive to the trigger of the control function, preliminary guidance configured to impact consumption of electricity at the plurality of sites. The data processing system can be configured to construct, using the natural language-based protocol, a prompt comprising the preliminary guidance and a request for second information related to consumption of electricity in accordance with the preliminary guidance. The data processing system can be configured to transmit the prompt to the plurality of edge devices. The data processing system can be configured to receive, from the plurality of edge devices, preliminary information in response to the prompt comprising the preliminary guidance. The data processing system can be configured to determine, based on the preliminary information, that the preliminary guidance satisfies a condition related to the characteristic of electricity. The data processing system can be configured to generate, responsive to the determination, the guidance based on the preliminary guidance.

The data processing system can be configured to generate, based on the information and the layout of the electricity distribution grid, responsive to the trigger of the control function, preliminary guidance configured to impact consumption of electricity at the plurality of sites. The data processing system can be configured to construct, using the natural language-based protocol, a prompt comprising the preliminary guidance and a request for second information related to consumption of electricity in accordance with the preliminary guidance. The data processing system can be configured to transmit the prompt to the plurality of edge devices. The data processing system can be configured to receive, from the plurality of edge devices, preliminary information in response to the prompt comprising the preliminary guidance. The data processing system can be configured to determine, based on the preliminary information, that the preliminary guidance does not satisfy a condition related to the characteristic of electricity.

The data processing system can be configured to generate, responsive to the determination, a second prompt with second preliminary guidance. The data processing system can be configured to generate the guidance responsive to second information responsive to the second prompt satisfying the condition related to the characteristic of electricity. The data processing system can be configured to determine, based on a type of control function, to generate a prompt related to quantitative analysis. The data processing system can be configured to transmit the prompt related to quantitative analysis to the plurality of edge devices to cause the plurality of edge devices to generate, using the generative machine learning model executed by the plurality of edge devices, processor-executable instructions to perform the quantitative analysis in accordance with the prompt.

The data processing system can be configured to receive the information in response to the plurality of edge devices executing the generated processor-executable instructions to perform the quantitative analysis in accordance with the prompt. The natural language-based protocol can be constructed dynamically on-the-fly using the generative machine learning model and a knowledge base related to the electricity distribution grid. The knowledge base can include a topology of the electricity distribution grid. The data processing system can be further configured to generate the guidance in accordance with a constraint established for the electricity distribution grid.

An aspect of the technical solutions is directed to a method. The method can include a data processing system comprising one or more processors coupled with memory, triggering a control function, based on a characteristic of electricity related to an electricity distribution grid. The data processing system can be located remote from a plurality of edge devices located at a plurality of sites in the electricity distribution grid. The method can include the data processing system pinging, using a natural language-based protocol compatible with a generative machine learning model, the plurality of edge devices for data related to consumption of electricity via the electricity distribution grid. The method can include the data processing system receiving, from the plurality of edge devices, information in response to the ping. The information can include a data structure generated via the generative machine learning model executed by each of the plurality of edge devices. The method can include the data processing system generating, based on the information and a layout of the electricity distribution grid, responsive to the trigger of the control function, guidance configured to impact the characteristic of electricity at the plurality of sites. The method can include the data processing system transmitting, to the plurality of edge devices, the guidance to impact the characteristic of electricity at the plurality of sites.

The method can include detecting, by the data processing system, a peak in demand of electricity on the electricity distribution grid. The method can include triggering, by the data processing system, based on identification of the peak, the control function to flatten the demand. The method can include pinging, by the data processing system, prior to triggering the control function, the plurality of edge devices for a prediction related to consumption of electricity over a time interval. The method can include detecting, by the data processing system, a peak in demand of electricity during the time interval based on receipt of responses responsive to the ping. The method can include triggering, by the data processing system, the control function responsive to detection of the peak in the demand during the time interval.

The method can include constructing, by the data processing system, using the natural language-based protocol, a prompt defining a format for the information generated by the plurality of edge devices. The method can include pinging, by the data processing system, the plurality of edge devices using the prompt. The method can include receiving, by the data processing system, the information in accordance with the format defined in the prompt.

The method can include determining, by the data processing system, based on the information, to perform a second ping, using the natural language-based protocol, of the plurality of edge devices prior to generation of the guidance. The method can include receiving, by the data processing system, from the plurality of edge devices, second information responsive to the second ping. The method can include generating, by the data processing system, the guidance based on the second information.

The method can include generating, by the data processing system, based on the information and a layout of the electricity distribution grid, responsive to the trigger of the control function, preliminary guidance configured to impact consumption of electricity at the plurality of sites. The method can include constructing, by the data processing system, using the natural language-based protocol, a prompt comprising the preliminary guidance and a request for second information related to consumption of electricity in accordance with the preliminary guidance. The method can include transmitting, by the data processing system, the prompt to the plurality of edge devices.

The method can include receiving, by the data processing system, from the plurality of edge devices, preliminary information in response to the prompt comprising the preliminary guidance. The method can include determining, by the data processing system, based on the preliminary information, that the preliminary guidance satisfies a condition related to the characteristic of electricity. The method can include generating, by the data processing system, responsive to the determination, the guidance based on the preliminary guidance.

An aspect of the technical solutions is directed to a non-transitory computer-readable storage medium storing processor-executable instructions. The instructions, when executed by one or more processors, can cause the one or more processors to trigger, based on a characteristic of electricity related to the electricity distribution grid, a control function. The instructions, when executed by one or more processors, can cause the one or more processors to ping, using a natural language-based protocol compatible with a generative machine learning model, a plurality of edge devices for data related to consumption of electricity via an electricity distribution grid. The one or more processors can be located remote from the plurality of edge devices located at a plurality of sites in the electricity distribution grid. The instructions, when executed by one or more processors, can cause the one or more processors to receive, from the plurality of edge devices, information in response to the ping, the information comprising a data structure generated via the generative machine learning model executed by each of the plurality of edge devices. The instructions, when executed by one or more processors, can cause the one or more processors to generate, based on the information and a layout of the electricity distribution grid, responsive to the trigger of the control function, guidance configured to impact the characteristic of electricity at the plurality of sites. The instructions, when executed by one or more processors, can cause the one or more processors to transmit, to the plurality of edge devices, the guidance to impact the characteristic of electricity at the plurality of sites.

The technical solutions can include a data processing system comprising one or more processors coupled to memory and communicatively coupled to a plurality of metering devices. The data processing system can generate, using a natural language model (NLM), instructions satisfying criteria for generating results or providing control actions, provide the instructions to at least one of the plurality of metering devices to generate and execute a code for obtaining the results or executing at least one of the control actions, and receive the results or verification of at least one of the control actions taken from the at least one of the plurality of metering devices.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

### BRIEF DESCRIPTION OF THE FIGURES

The accompanying drawings are not intended to be drawn to scale. Like reference numbers and designations in the various drawings indicate like elements having similar structure or functionality. For purposes of clarity, not every component may be labeled in every drawing. In the drawings:

FIG. 1 is a block diagram depicting an illustrative utility grid, in accordance with an implementation;

FIG. 2 is a block diagram of a system for providing a grid-scale natural-language-interactive analysis monitoring and control platform, in accordance with an implementation;

FIG. 3 is a block diagram of components of a machine learning framework implemented as a coordinator energy framework (CEF), in accordance with an implementation;

FIG. 4 is a block diagram of components of a machine learning framework implemented as an edge energy framework (EEF), in accordance with an implementation;

FIG. 5 is a block diagram of a coordinator agent and edge agent structure, in accordance with an implementation;

FIG. 6 is a block diagram illustrating an architecture for a computer system that can be employed to implement elements of the systems and methods described and illustrated herein, including, for example, aspects of the utility grid and its components, discussed in connection with FIGS. 1-5.

FIG. 7 is a flow diagram of a method for providing a grid-scale natural-language-interactive analysis monitoring and control platform, in accordance with an implementation.

The features and advantages of the present solution will become more apparent from the detailed description set forth below when taken in conjunction with the drawings, in which like reference characters identify corresponding elements throughout. Other features, aspects, and advantages of the subject matter will become apparent from the description, the drawings, and the claims.

### DETAILED DESCRIPTION

Following below are more detailed descriptions of various concepts related to, and implementations of, methods, apparatuses, and systems of grid-scale natural-language-interactive analysis monitoring and control platform. The various concepts introduced above and discussed in greater detail below may be implemented in any of numerous ways.

In utility distribution grids, meters or other components within utility distribution grids can collect samples of power delivery or consumption at respective sites (e.g., residential homes, facilities, or entities) for processing. In certain cases, loads can be fed or operated from diverse energy sources, e.g., gasoline, propane, oil, wood, natural gas, or electricity. These loads may include but are not limited to heating, cooling, cooking, appliances, equipment, yard tools, automobiles, or other loads at the grid edge. Because of the continuing electrification, these loads (e.g., appliances, devices, items, or machines) may be unified under a single energy source (e.g., electricity). With the electrification and unification of the loads or electrical devices at the grid edge under the single energy source, it may be challenging for electric utilities to support the increased current flows. For instance, the process of upgrading the physical equipment to support the increased current flows may be longer than the pace of electrification, potentially risking early failure of utility equipment due to overuse.

In certain systems, a non-physical approach may be implemented, such as modulating flexible or controllable loads via pricing, discouraging use at peak times to reduce electrical usage at certain time periods (e.g., flatten the curve), e.g., as the total current flows increase, the peak levels can be maintained below predefined hardware limits. In some cases, the non-physical approach may include charging energy storage at the edge during off-peak times and discharging the energy storage during peak times, alleviating the magnitude of modulation by the flexible or controllable loads. The tradeoff for such non-physical implementations may involve the extended utilization of existing, physical grid infrastructure (e.g., reducing cost for consumers through the deferral of equipment upgrades) at the expense of complexifying its end-to-end operation (e.g., actions taken by the consumer). The increase in complexity may demand more actions to be taken by the consumers for cost-effective use of energy, for instance, compared to the diverse energy sources. To address these challenges from the electrification of loads, the systems and methods of the technical solution can provide the ability to measure power consumption and generation at the grid edge (e.g., sampled by the respective meters) and process the data (e.g., by the meters at the site) to assist the consumers as discussed herein.

Grid edge data and control can be beneficial at an edge location, for instance, because the edge devices can process the grid edge data (e.g., with relatively high resolution), allowing for increased accuracy in determining or predicting electrical consumption or generation at the edge location, while reducing network traffic by minimizing grid edge data transmission to the network or a remote computing device. The grid edge data can be beneficial in the context of larger-scale analysis tasks over the entire grid, or at least a subset of the grid. Such grid edge data can be beneficial for various entities, including grid operators with limited visibility of fine-grained measurements over the grid that the operators are managing and controlling. Therefore, the systems and methods can support grid-scale data collection, analysis, or control to contribute to the evolution and optimization of the electrical grid. The systems and methods discussed herein can allow for the synthesis of grid-edge data with grid-scale analysis or objectives, for instance, to control one or more components of the electrical grid.

The systems and methods can provide various energy-measurement and data-processing benefits by performing grid-scale data collection, analysis, and control, and synthesizing the grid-edge data with grid-scale analysis (or objectives). The benefits can be grouped into multiple categories. For example, the systems and methods can at least one of improve the utilization of the grid equipment, improve the monitoring or forecasting of electrical consumption by the grid equipment, or minimize the wear-and-tear (from overuse) of the grid equipment. In another example, the systems and methods can understand or learn the usage or other factors that affect the reliability or resilience of the grid, e.g., to improve various grid metrics, such as energy measurement and data processing. In further examples, the systems and methods can optimize the flexible or controllable loads and DERs according to the collected grid-scale data and processing of the data.

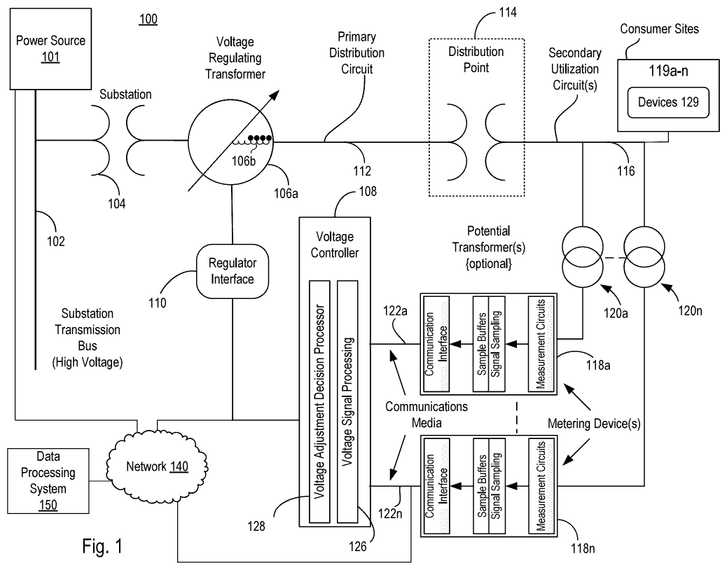

Referring now to FIG. 1, an example utility distribution environment is shown. The utility distribution environment can include a utility grid 100. The utility grid 100 can include an electricity distribution grid with one or more devices, assets, or digital computational devices and systems, such as a data processing system 150. In brief overview, the utility grid 100 includes a power source 101 that can be connected via a subsystem transmission bus 102 or via substation transformer 104 to a voltage regulating transformer 106a. The voltage regulating transformer 106a can be controlled by voltage controller 108 with regulator interface 110. Voltage regulating transformer 106a can be optionally coupled on primary distribution circuit 112 via optional distribution transformer 114 to secondary utilization circuits 116 and to one or more electrical or electronic devices 129. Voltage regulating transformer 106a can include multiple tap outputs 106b with each tap output 106b supplying electricity with a different voltage level. The utility grid 100 can include monitoring devices 118a-118n that can be coupled through optional potential transformers 120a-120n to secondary utilization circuits 116. The monitoring or metering devices 118a-118n can detect (e.g., continuously, periodically, based on a time interval, responsive to an event or trigger) measurements and continuous voltage signals of electricity supplied to one or more electrical devices 129 connected to circuit 112 or 116 from a power source 101 coupled to bus 102. A voltage controller 108 can receive, via a communication media 122, measurements obtained by the metering devices 118a-118n and use the measurements to make a determination regarding a voltage tap settings and provide an indication to regulator interface 110. The regulator interface can communicate with voltage regulating transformer 106a to adjust an output tap level 106b.

Still referring to FIG. 1, and in further detail, the utility grid 100 includes a power source 101. The power source 101 can include a power plant such as an installation configured to generate electrical power for distribution. The power source 101 can include an engine or other apparatus that generates electrical power. The power source 101 can create electrical power by converting power or energy from one state to another state. In some embodiments, the power source 101 can be referred to or include a power plant, power station, generating station, powerhouse or generating plant. In some embodiments, the power source 101 can include a generator, such as a rotating machine that converts mechanical power into electrical power by creating relative motion between a magnetic field and a conductor. The power source 101 can use one or more energy source to turn the generator including, e.g., fossil fuels such as coal, oil, and natural gas, nuclear power, or cleaner renewable sources such as solar, wind, wave and hydroelectric.

In some embodiments, the utility grid 100 includes one or more substation transmission bus 102. The substation transmission bus 102 can include or refer to transmission tower, such as a structure (e.g., a steel lattice tower, concrete, wood, etc.), that supports an overhead power line used to distribute electricity from a power source 101 to a substation 104 or distribution point 114. Transmission towers 102 can be used in high-voltage alternating current (AC) and direct current (DC) systems and come in a wide variety of shapes and sizes. In an illustrative example, a transmission tower can range in height from 15 to 55 meters or more. Transmission towers 102 can be of various types including, e.g., suspension, terminal, tension, and transposition. In some embodiments, the utility grid 100 can include underground power lines in addition to or instead of transmission towers 102.

In some embodiments, the utility grid 100 includes a substation 104 or electrical substation 104 or substation transformer 104. A substation can be part of an electrical generation, transmission, and distribution system. In some embodiments, the substation 104 transform voltage from high to low, or the reverse, or performs any of several other functions to facilitate the distribution of electricity. In some embodiments, the utility grid 100 can include several substations 104 between the power plant 101 and the consumer electrical devices 129 with electric power flowing through them at different voltage levels.

The substations 104 can be remotely operated, supervised and controlled (e.g., via a supervisory control and data acquisition system or data processing system 150). A substation can include one or more transformers to change voltage levels between high transmission voltages and lower distribution voltages, or at the interconnection of two different transmission voltages.

The regulating transformer 106 can include: (1) a multi-tap autotransformer (single or three phase), which are used for distribution; or (2) on-load tap changer (three phase transformer), which can be integrated into a substation transformer 104 and used for both transmission and distribution. The illustrated system described herein can be implemented as either a single-phase or three-phase distribution system. The utility grid 100 can include an AC power distribution system and the term voltage can refer to a root mean square voltage, in some embodiments.

The utility grid 100 can include a distribution point 114 or distribution transformer 114, which can refer to an electric power distribution system. In some embodiments, the distribution point 114 can be a final or near final stage in the delivery of electric power. For example, the distribution point 114 can carry electricity from the transmission system (which can include one or more transmission towers 102) to individual consumers or consumer sites 119. In some embodiments, the distribution system can include the substations 104 and connect to the transmission system to lower the transmission voltage to medium voltage ranging between 2 kV and 35 kV with the use of transformers, for example. Primary distribution lines or circuit 112 carry this medium voltage power to distribution transformers located near the customer's premises 119. Distribution transformers can further lower the voltage to the utilization voltage of appliances and can feed several customers or customer sites 119 through secondary distribution lines or circuits 116 at this voltage. Commercial and residential customers or customer sites 119 can be connected to the secondary distribution lines through service drops. In some embodiments, customers demanding high load can be connected directly at the primary distribution level or the sub-transmission level.

The utility grid 100 can include or couple to one or more consumer sites 119. Consumer sites 119 can include, for example, a building, house, shopping mall, factory, office building, residential building, commercial building, stadium, movie theater, etc. The consumer sites 119 can be configured to receive electricity from the distribution point 114 via a power line (above ground or underground). A consumer site 119 can be coupled to the distribution point 114 via a power line. The consumer site 119 can be further coupled to a site meter 118a-n or advanced metering infrastructure (AMI). The site meter 118a-n can be associated with a controllable primary circuit segment 112. The association can be stored as a pointer, link, field, data record, or other indicator in a data file in a database.

The utility grid 100 can include site meters 118a-n or AMI. Site meters 118a-n can measure, collect, and analyze energy usage, and communicate with metering devices such as electricity meters, gas meters, heat meters, and water meters, either on request or on a schedule. Site meters 118a-n can include hardware, software, communications, consumer energy displays and controllers, customer associated systems, Meter Data Management (MDM) software, or supplier business systems. In some embodiments, the site meters 118a-n can obtain samples of electricity usage in real time or based on a time interval, and convey, transmit or otherwise provide the information. In some embodiments, the information collected by the site meter can be referred to as meter observations or metering observations and can include the samples of electricity usage. In some embodiments, the site meter 118a-n can convey the metering observations along with additional information such as a unique identifier of the site meter 118a-n, unique identifier of the consumer, a time stamp, date stamp, temperature reading, humidity reading, ambient temperature reading, etc. In some embodiments, each consumer site 119 (or electronic device) can include or be coupled to a corresponding site meter or monitoring device 118a-118n.

Monitoring devices 118a-118n can be coupled through communications media 122a-122n to voltage controller 108. Voltage controller 108 can compute (e.g., discrete-time, continuously or based on a time interval or responsive to a condition or event) values for electricity that facilitates regulating or controlling electricity supplied or provided via the utility grid. For example, the voltage controller 108 can compute estimated deviant voltage levels that the supplied electricity (e.g., supplied from power source 101) will not drop below or exceed as a result of varying electrical consumption by the one or more electrical devices 129. The deviant voltage levels can be computed based on a predetermined confidence level and the detected measurements. Voltage controller 108 can include a voltage signal processing circuit 126 that receives sampled signals from metering devices 118a-118n. Metering devices 118a-118n can process and sample the voltage signals such that the sampled voltage signals are sampled as a time series (e.g., uniform time series free of spectral aliases or non-uniform time series).

Voltage signal processing circuit 126 can receive signals via communications media 122a-n from metering devices 118a-n, process the signals, and feed them to voltage adjustment decision processor circuit 128. Although the term “circuit” is used in this description, the term is not meant to limit this disclosure to a particular type of hardware or design, and other terms known generally known such as the term “element”, “hardware”, “device” or “apparatus” could be used synonymously with or in place of term “circuit” and can perform the same function. For example, in some embodiments the functionality can be carried out using one or more digital processors, e.g., implementing one or more digital signal processing algorithms. Adjustment decision processor circuit 128 can determine a voltage location with respect to a defined decision boundary and set the tap position and settings in response to the determined location. For example, the adjustment decision processing circuit 128 in voltage controller 108 can compute a deviant voltage level that is used to adjust the voltage level output of electricity supplied to the electrical device. Thus, one of the multiple tap settings of regulating transformer 106 can be continuously selected by voltage controller 108 via regulator interface 110 to supply electricity to the one or more electrical devices based on the computed deviant voltage level. The voltage controller 108 can also receive information about voltage regulator transformer 106a or output tap settings 106b via the regulator interface 110. Regulator interface 110 can include a processor-controlled circuit for selecting one of the multiple tap settings in voltage regulating transformer 106 in response to an indication signal from voltage controller 108. As the computed deviant voltage level changes, other tap settings 106b (or settings) of regulating transformer 106a are selected by voltage controller 108 to change the voltage level of the electricity supplied to the one or more electrical devices 129.

The network 140 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, or 4G. The network standards can qualify as one or more generation of mobile telecommunication standards by fulfilling a specification or standards such as the specifications maintained by International Telecommunication Union. The 3G standards, for example, can correspond to the International Mobile Telecommunications-3000 (IMT-3000) specification, and the 4G standards can correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards can use various channel access methods, including, e.g., FDMA, TDMA, CDMA, or SDMA. In some embodiments, different types of data can be transmitted via different links and standards. In other embodiments, the same types of data can be transmitted via different links and standards.

The network 140 can be any type or form of network. The geographical scope of the network 140 can vary widely and the network 140 can be a body area network (BAN), a personal area network (PAN), a local-area network (LAN), e.g. Intranet, a metropolitan area network (MAN), a wide area network (WAN), or the Internet. The topology of the network 140 can be of any form and can include, e.g., any of the following: point-to-point, bus, star, ring, mesh, or tree. The network 140 can be an overlay network which is virtual and sits on top of one or more layers of other networks 140. The network 140 can be of any such network topology as known to those ordinarily skilled in the art capable of supporting the operations described herein. The network 140 can utilize different techniques and layers or stacks of protocols, including, e.g., the Ethernet protocol, the internet protocol suite (TCP/IP), the Asynchronous Transfer Mode (ATM) technique, the Synchronous Optical Networking (SONET) protocol, or the Synchronous Digital Hierarchy (SDH) protocol. The TCP/IP internet protocol suite can include application layer, transport layer, internet layer (including, e.g., IPv6), or the link layer. The network 140 can be a type of a broadcast network, a telecommunications network, a data communication network, or a computer network.

The network 140 can include computer networks such as the internet, local, wide, near field communication, metro or other area networks, as well as satellite networks or other computer networks such as voice or data mobile phone communications networks, and combinations thereof. The network 140 can include a point-to-point network, broadcast network, telecommunications network, asynchronous transfer mode network, synchronous optical network, or a synchronous digital hierarchy network, for example. The network 140 can include at least one wireless link such as an infrared channel or satellite band. The topology of the network 140 can include a bus, star, or ring network topology. The network 140 can include mobile telephone or data networks using any protocol or protocols to communicate among vehicles or other devices, including advanced mobile protocols, time or code division multiple access protocols, global system for mobile communication protocols, general packet radio services protocols, or universal mobile telecommunication system protocols, and the same types of data can be transmitted via different protocols.

One or more components, assets, or devices of utility grid 100 can communicate via network 140. The utility grid 100 can use one or more networks, such as public or private networks. The utility grid 100 can communicate or interface with a data processing system 150 designed and constructed to communicate, interface or control the utility grid 100 via network 140. Each asset, device, or component of utility grid 100 can include one or more computing devices 600 or a portion of computing device 600 or some or all functionality of computing device 600.

The data processing system 150 can reside on a computing device of the utility grid 100, or on a computing device or server external from, or remote from the utility grid 100. The data processing system 150 can reside or execute in a cloud computing environment or distributed computing environment. The data processing system 150 can reside on or execute on multiple local computing devices located throughout the utility grid 100. For example, the utility grid 100 can include multiple local computing devices each configured with one or more components or functionality of the data processing system 150.

Each of the components of the data processing system 150 can be implemented using hardware or a combination of software and hardware. Each component of the data processing system 150 can include logical circuitry (e.g., a central processing unit or CPU) that responses to and processes instructions fetched from a memory unit (e.g., memory 315 or storage device 325). Each component of the data processing system 150 can include or use a microprocessor or a multi-core processor. A multi-core processor can include two or more processing units on a single computing component. Each component of the data processing system 150 can be based on any of these processors, or any other processor capable of operating as described herein. Each processor can utilize instruction level parallelism, thread level parallelism, different levels of cache, etc. For example, the data processing system 150 can include at least one logic device such as a computing device or server having at least one processor to communicate via the network 140.

The components and elements of the data processing system 150 can be separate components, a single component, or part of the data processing system 150. For example, individual components or elements of the data processing system 150 can operate concurrently to perform at least one feature or function discussed herein. In another example, components of the data processing system 150 can execute individual instructions or tasks. The components of the data processing system 150 can be connected or communicatively coupled to one another. The connection between the various components of the data processing system 150 can be wired or wireless, or any combination thereof. Counterpart systems or components can be hosted on other computing devices.

The data processing system 150 can communicate with one or more metering devices 118 via the network 140. In some cases, the data processing system 150 can include features or functionalities of the metering devices 118. In some other cases, the data processing system 150 can be a part of the metering device 118, such that the metering device 118 can perform certain features or functionalities of the data processing system 150. The data processing system 150 can include a graphical user interface (GUI) to display information to the user. The data processing system 150 can include one or more processing units, such as a graphics processing unit (GPU), to perform local processing at a local site (e.g., grid edge or at a residential area).

In some configurations, the data processing system 150 can be a metering device 118. In some other configurations, the data processing system 150 can be a separate component or device, independent from the metering device 118. For purposes of providing examples herein, the data processing system 150 may be a separate device from the metering device 118. It should be noted that one or more features or functionalities of the data processing system 150 or the metering device 118 can be shared or similar between each other. For example, the data processing system 150 can include or execute a coordinator agent (e.g., sometimes referred to as a central agent). Each metering device 118 can include or execute an edge agent (e.g., sometimes referred to as a local agent). The coordinator agent can include one or more features or functionalities of one or more edge agents, for example.

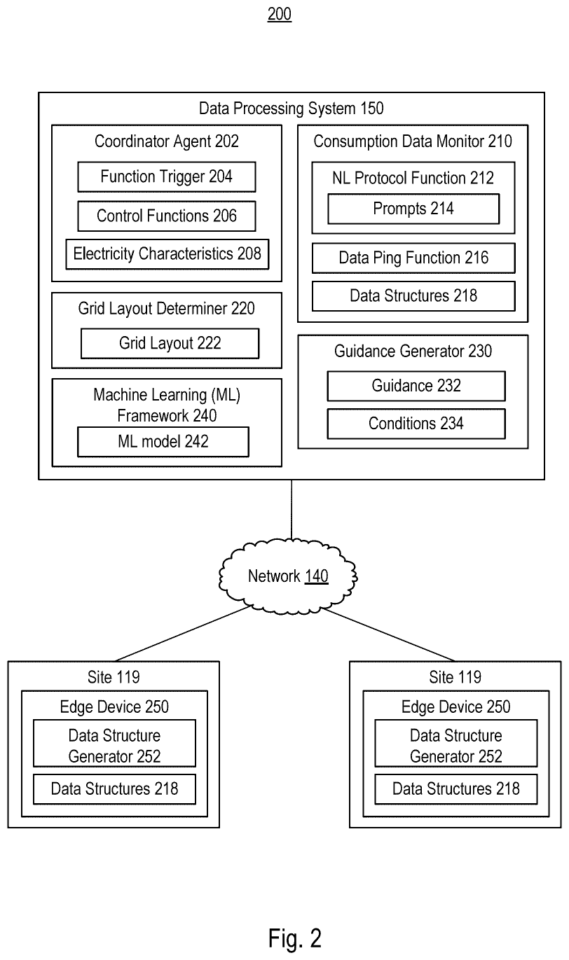

FIG. 2 illustrates an example system 200 for neutral-language-interactive analysis monitoring and control platform of electrical grids. The example system 200 can an electricity distribution grid, such as the grid 100 of FIG. 1, which can have one or more data processing systems 150 communicatively coupled, via one or more networks 140, with one or more edge devices 250 at one or more sites 119. Each of the edge devices 250 can include, or be communicatively coupled with, one or more data structure generators 252 that can utilize one or more machine learning (ML) models 242 to generate data structures 218 related to data on consumption of electricity that can be requested by the data processing system 150.

Across the network 140, the data processing system 150 can include one or more of coordinator agents 202 that can include or utilize one or more function triggers 204 to trigger control functions 206 based on different electricity characteristics 208 of the electricity distribution grid 100. The data processing system 150 can include one or more consumption data monitors 210 to use one or more natural language (NL) protocol functions 212 to provide a natural language-based protocol compatible with one or more generative ML models 242. The natural language-based protocol can be used by the data ping function 216 of the consumption data monitor 210 to ping (e.g., via one or more prompts 214 for the one or more ML models 242) the edge devices 250 at various sites 119 for data on consumption of electricity via the grid. The consumption data monitor 210 can receive (e.g., from the edge devices 250 across the grid) one or more data structures 218 that were generated by the generative ML models 242 executed by the data structure generators 252 of the edge devices 250. The data processing system 150 can include one or more grid layout determiners 220 for identifying, acquiring or determining grid layout 222 (e.g., a topology of the grid). The data processing system 150 can include one or more guidance generators 230 for generating guidance 232 (e.g., instructions or commands) to cause an adjustment or impact on the electricity characteristics 208 at the sites 119 of the edge devices 250, based on the grid layout 222 and the information (e.g., the data structures 218) received from the edge devices 250, responsive to the trigger of the control function 206. The guidance generator 230 can generate the guidance 232 according to various conditions 234 (e.g., constraints) on the electricity grid, as well as transmit such generated guidance 232 to edge devices 250 at the sites 119 to impact or adjust the electricity characteristics 208 at those sites. The data processing system 150 can include one or more ML frameworks 240 for providing the ML models 242 for use by any one or more of: the consumption data monitors 210 for pinging or requesting electricity consumption data (e.g., to receive data structures 218 from the edge devices 250), the data structure generators 252 of the edge devices 250 to generate the information (e.g., the data structure 218) in response to the ping for data on electricity consumption from the consumption data monitor 210, or the guidance generator 230 for generating the guidance 232 for transmission to the edge devices 250 at the sites 119.

Data processing system 150 can include any combination of hardware and software for providing a natural-language-interactive analysis monitoring and control functionality for a grid system. Data processing system 150 can be located remotely from the edge devices 250 and can communicate with the edge devices 250 via one or more networks 140. Data processing system 150 can trigger control functions 206 based on electricity characteristics 208. Data processing system 150 can request or ping edge devices 250 for data on electricity consumption, and can receive information (e.g., in the form of data structures 218) from the edge devices 250 at various sites 119. Data processing system 150 can generate guidance 232 based on the received data and the grid layout 222 and can transmit this guidance 232 to the edge devices 250. Data processing system 150 can include components such as coordinator agents 202, function triggers 204, consumption data monitors 210, and guidance generators 230. Data processing system 150 can also utilize ML frameworks 240 to provide ML models 242 for performing various functionalities of any of the components of the data processing system 150.

Coordinator agent 202 can include any combination of hardware and software for coordinating communication between the data processing system 150 and the edge devices 250. Coordinator agent 202 can utilize function triggers 204 to trigger or initiate control functions based on different electricity characteristics 208 of the grid. Coordinator agent 202 can manage the communication between the data processing system 150 and the edge devices 250 based on various electricity characteristics 208 (e.g., changes or statuses of voltage, current, power consumption, or power generation) to use for generating guidance 232 to manage various conditions at the grid (e.g., specific electricity characteristics 208 at particular portions of the grid). Coordinator agent 202 can utilize control functions 206 to adjust power consumption, manage energy storage, or balance supply and demand based on real-time data and conditions at the grid. The data processing system 150 can utilize the coordinator agent 202 to handle the distribution of guidance generated by the data processing system 150 to the edge devices 250.

Function trigger 204 can include any combination of hardware and software for triggering control functions based on specific electricity characteristics 208. Function trigger 204 can be part of the coordinator agent 202 and can initiate actions such as adjusting power consumption or generation. Function trigger 204 can detect peaks in electricity demand and trigger control functions to flatten the demand. For example, the function trigger can utilize a control function 206 to reduce power consumption during peak times by adjusting the operation of flexible loads or by managing energy storage systems to discharge stored energy. Function trigger 204 can operate with the data ping function 216 to ping edge devices 250 for predictions related to electricity consumption and trigger control functions based on these predictions. Function trigger 204 can transmit guidance 232 with instructions to adjust the operation of the grid and therefore cause the edge devices 250 to adjust electricity characteristics 208 (e.g., change operations impacting electricity distribution) at their respective sites 119 or respective portions of the grid.

Control function 206 can include any combination of hardware and software for performing specific actions to adjust, control or manage the electricity distribution grid. Control function 206 can be triggered by the function trigger 204 based on one or more electricity characteristics 208 reaching particular thresholds or constraints. Control function 206 can include actions such as adjusting power consumption, managing energy storage, balancing supply and demand, modulating flexible loads, implementing demand response strategies, adjusting charge and discharge times of DERs, and controlling the charging and discharging of electric vehicles. Control function 206 can be used to prevent or reduce energy losses, electricity instability, and power outages. Control function 206 can be designed to respond to real-time data and conditions (e.g., in response to electricity characteristics 208 satisfying their respective threshold conditions or constraints), allowing for adjusted grid operation and improvement of grid stability and efficiency.

Electricity characteristic 208 can include any measurable attribute or parameter related to the electricity distribution grid. Examples of electricity characteristics 208 can include voltage, current, power consumption, and power generation. These characteristics can be monitored by the data processing system 150 and used to trigger control functions 206. Electricity characteristics 208 can provide valuable information about the state of the grid and help identify potential issues. By monitoring these characteristics, the data processing system 150 can ensure that the grid operates efficiently and reliably. Electricity characteristics 208 can also be used to generate guidance for the edge devices 250 to adjust their operation. For example, the data processing system 150 can use electricity characteristics 208 (e.g., measurements of voltage, current or power over a time interval, such as one or more days or weeks) to detect a periodic (e.g., daily) peak in electricity demand and trigger control functions 206 to flatten the demand. For example, electricity characteristics 208 can be used to predict future consumption patterns, allowing the data processing system 150 to proactively manage the grid's load, based on the predictions in order to offset predicted peaks by providing guidance 232 to offset the charging or discharging times of electric vehicles (EVs) or DERs.

Consumption data monitor 210 can include any combination of hardware and software for monitoring, gathering, or acquiring information or data on electricity consumption from various edge devices 250 on various sites 119 across the grid. Consumption data monitor 210 can use NL protocol functions 212 to provide a natural language-based protocol compatible with generative ML models 242. Consumption data monitor 210 can ping edge devices 250 for data on electricity consumption and receive data structures 218 generated by the ML models executed by the edge devices 250. Consumption data monitor 210 can help the data processing system 150 gather accurate and real-time information (e.g., via electricity characteristics 208 gathered by the data processing system 150 from various edge devices 250) about electricity consumption across the grid.

NL protocol function 212 can include any combination of hardware and software for providing a natural language-based protocol or generating natural language requests for, or compatible with, ML models 242. NL protocol function 212 can be used by the consumption data monitor 210 to generate messages or communications (e.g., prompts 214) to communicate with edge devices 250. The edge devices 250 can receive the NL requests (e.g., pings or the prompts 214) and use the contents of such requests to generate data structures 218. The NL protocol function 212 can construct prompts 214 for the ML models and use the data ping function 216 to ping edge devices 250 for data. NL protocol function 212 can use natural language requests or prompts 214 as inputs into one or more ML models 242 to generate pings requesting data on consumption of electricity at the electricity distribution grid from edge devices 250. The NL protocol function 212 can facilitate the data processing system 150 to gather the information (e.g., data structures 218) with information formatted in various formats to be used as inputs by the guidance generator 230 to generate guidance 232 (e.g., instructions or commands) for edge devices 250 across the grid to adjust the electrical distribution operations (e.g., timing of charging and discharging, amount of power used at given times) to adjust electricity distribution to impact (e.g., adjust or change) the electricity characteristics 208.

The natural language protocol can include any form or format of communication between the data processing system 150 and the edge devices 250 using natural language-based commands. The natural language protocol can be compatible with generative machine learning models 242, allowing the data processing system 150 to construct prompts 214 and send them to the edge devices 250 using natural language descriptions. The NL protocol can be used by the ML models 242 to ping edge devices 250 for data on electricity consumption and receive data structures 218 generated by the ML models executed by the edge devices 250. By using natural language commands, the protocol can simplify the interaction between the data processing system 150 and the edge devices 250, making it easier to gather accurate and timely information, as well as to monitor this process.

Prompt 214 can include any combination of hardware and software, including any string of characters, instructions or data, for controlling or managing operation of ML models 242. Prompt 214 can be constructed for operations of ML models 242 for a variety of operations, such as generating and transmitting pings to edge devices 250, generating data structures 218 by the edge devices 250 in response to received pings or using data structures 218, electricity characteristics 208 or grid layout 222 for generating guidance 232. Prompts 214 can be used by the NL protocol function 212 to communicate with the ML models 242 executed by the edge devices 250. Prompts 214 can define the format or content of the data related to consumption of electricity requested (e.g., by the data ping function 216) from the edge devices 250. Prompts 214 can validate that the data received by the data processing system 150 is accurate and in a usable format. For example, prompts 214 can include specific validation rules and formatting instructions to ensure data integrity and consistency, such as by specifying acceptable ranges for data values (e.g., voltage or current) to ensure that the received data falls within expected parameters and is reliable for further processing. Prompts 214 can be designed to be compatible with the natural language-based protocol used by the data processing system 150.

An example of a prompt 214 can include, for example, various texts, contents or messages inquiring about power outage, such as: “Tell me when or where is an outage.” Prompt 214 can include text, such as, determinations for amount of power that can be saved or acquired by moving a demand response, such as “how many megawatts could we get if we were to call a demand response event tomorrow at 16:00 hours?” Prompt 214 can include statements or texts, such as “Find all instances of transformers being mis-mapped to homes”, or “How much did all EVs/PV in X service territory consume yesterday?”, or “How many BESSs are installed in X service territory?”, or “What load on which feeders should I shed to minimize the PPAC charge?”, or “For all meters on a feeder X, monitor conditions over the next X days, and if you see EV charging coupled with power-quality issues, log the waveforms for a 30-second window.”

Data ping function 216 can include any combination of hardware and software for sending requests for data to edge devices 250 and receiving responses. Data ping function 216 can include computer code, instructions or data for generating and transmitting requests (e.g., pings) for information or data related to consumption of energy at various sites 119 of the grid. For instance, the data ping function 216 can be used by the consumption data monitor 210 to ping the edge devices 250 periodically, triggering an updated generation of data related to consumption of electricity to be gathered by the edge devices 250 in response to the ping. Data ping function 216 can use prompts 214 to request data from the ML models 242 executed by the edge devices 250. Data ping function 216 can receive accurate and timely information about electricity consumption across the grid via data structures 218 (e.g., from various edge devices 250 at various sites 119).

Data structure 218 can include any combination of hardware and software for organizing and storing data related to electricity consumption. Data structure 218 can be generated by the ML models 242 executed by the data structure generators 252 of the edge devices 250. Data structures 218 can include information such as voltage, current, power consumption, and power generation. Data structure 218 can include information on any electricity characteristics 208, which can be measured or monitored by devices for monitoring voltage, current, power on any of the edge devices 250. Data structure 218 can be, for example, a JSON object containing fields for voltage, current, power consumption, and power generation data collected from an edge device 250, describing the state of the electricity consumption at that particular site 119 or near (e.g., adjacent to) that site 119. Data structures 218 can be used by the data processing system 150 to generate guidance and control functions and can be organized in a format useable by the guidance generator 230 or its ML model 242.

Grid layout determiner 220 can include any combination of hardware and software for identifying, acquiring, or determining the layout or topology of the electricity distribution grid. Grid layout determiner 220 can be used by the data processing system 150 to gather information about the grid layout 222, such as the grid topology or arrangement of edge devices 250 and the corresponding sites 119. Grid layout determiner 220 can use data from various sources, such as edge devices 250 and other grid components on the network 140, to construct a representation of the grid layout 222 or topology.

Grid layout 222 can include any representation of a layout or topology of an electrical grid or a portion of the electrical grid. Grid layout 222 can be used by the data processing system 150 to generate guidance 232 and adjust or configure the control functions 206. Grid layout 222 can include information such as the location of edge devices 250, the configuration of the network 140, and the distribution of electricity across the grid. Grid layout 222 can help the data processing system 150 understand the structure and configuration of the grid, allowing for the data processing system 150 to make decisions on the state of the grid 100 and any electricity characteristics 208 to be adjusted.

Guidance generator 230 can include any combination of hardware and software for generating guidance or instructions to adjust, offset or impact electricity characteristics 208 (e.g., voltage, current or power) at particular sites 119 associated with edge devices 250. Guidance generator 230 can be used by the data processing system 150 to generate any guidance 232 (e.g., one or more instructions, data or descriptions) of steps or operations to perform to make adjustments to the consumption of electricity on the grid. The guidance generator 230 can include computer code, instructions or data to generate guidance 232 for any one or more edge devices 250 based on the grid layout 222 and the information received from the edge devices 250, such as data structures 218 describing electricity consumption at or near the sites 119 of the edge devices 250. The guidance generator 230 can validate or verify that the guidance generated is accurate and effective. For example, the guidance generator 230 can cross-check the generated guidance against predefined conditions 234, such as voltage limits or power consumption thresholds, to ensure compliance with grid constraints. The guidance generator 230 can simulate the impact of the guidance on the grid using historical data and predictive models to verify its effectiveness before implementation (e.g., prior to generating guidance 232). Guidance generator 230 can help the data processing system 150 respond to real-time data and conditions on the grid that can be detected responsive to continuous, real-time or periodic monitoring of the electricity characteristics 208 to improve the efficiency the operation of the grid. Guidance generator 230 can generate guidance 232 according to various conditions 234 and within any one or more constraints on the electricity grid.

Guidance 232 can include any combination instructions, commands or data to adjust electricity consumption and impact electricity characteristics 208 at particular sites 119 associated with the edge devices 250 on the grid. Guidance 232 can include, for example, information on preferred or acceptable range of electricity load or power consumed over any one or more time intervals. Guidance 232 can include, for example, any recommendations for load shedding during peak demand periods, instructions for optimizing the charging and discharging cycles of energy storage systems, or commands to adjust the operation of DERs to balance supply and demand. For instance, guidance 232 can specify actions to be taken in response to detected anomalies in electricity characteristics, such as voltage fluctuations or unexpected power surges, to maintain grid stability and reliability. The actions to be taken can include any combination of: adjusting (e.g., increasing or decreasing) power consumption during peak demand periods, adjusting the operation of DERs, adjusting charging and discharging cycles of energy storage systems, implementing load shedding or load balancing strategies, modulating flexible loads, balancing supply and demand, responding to voltage fluctuations, addressing unexpected power surges, addressing expected or predicted power surges by diverting power to other circuits to flatten the demand response or adjusting the operation or integration of renewable energy sources. Guidance 232 can include instructions or guidelines for edge devices 250 to adjust their operation or control of the electricity consumption on the grid in accordance with predetermined actions dictated by the guidance 232, thereby helping reduce or prevent energy losses or inefficiencies, electricity instability, and power outages.

Conditions 234 can include any operational parameters describing the state or operation of the electricity distribution grid. Conditions 234 can include constraints or parameters established for the electricity distribution grid. Conditions 234 can include or correspond to electricity characteristics 208 measured in relation to any thresholds or constraints. Conditions 234 can be used by the guidance generator 230 to generate or control the generation of the guidance 232. Conditions 234 can include factors such as voltage limits, current limits, and power consumption thresholds. Conditions 234 can identify or dictate timing (e.g., via timestamps of measured voltage, current or power values) as well as a state or a change in state of one or more electricity characteristics 208 over a time period.

Site 119 can include any location within the electricity distribution grid at which, near which, or adjacent to which, one or more edge devices 250 are installed. Site 119 can be part of the grid layout 222 and can include residential homes, commercial facilities, and industrial plants. Site 119 can be monitored by the data processing system 150 to gather information about electricity consumption and generation. Site 119 can include a portion of a grid having one or more load devices interconnected with one or more power sources. A site 119 can include a grid of its own that is adjacent to and connect to a utility power grid via an edge device 250 (e.g., a metering device 118) or any other device on the grid. Site 119 can include energy generating devices (e.g., photovoltaic or solar panels), energy storage devices (e.g., batteries), load devices (e.g., machines or devices consuming electricity) or any other devices on the grid.

Edge device 250 can include any combination of hardware and software for monitoring, gathering, or acquiring information or data on electricity consumption at any portion or any site 119 on a grid. Edge device 250 can include any device on a grid, such as a metering device 118 and can be deployed on any grids or between any two grids (e.g., between a utility and a separate grid of a site 119). Edge device 250 can be communicatively coupled with the data processing system 150 via one or more networks 140 or one or more power lines. Edge device 250 can include data structure generators 252 that utilize ML models 242 to generate data structures 218 related to electricity consumption. For instance, an edge device 250 can receive a ping from a data processing system 150 and in response to the ping, utilize a data structure generator 252 to generate a data structure 218 to provide back the data processing system 150. For instance, an edge device 250 can be configured to periodically make measurements of various electricity characteristics 208 at the site 119 or adjacent to the site 119 and in response to the ping provide the most recently updated snapshot of this data in the form of the data structure 218. For example, the edge device 250 can periodically (e.g., every 1, 5, 10, 15, 30, 45 or 60 minutes) measure electricity characteristics 208 and insert different electricity characteristics 208 readings (e.g., voltage, current, power over various time intervals) into data structures 218 to send to the coordinator agent 202, responsive to the ping.

Data structure generator 252 can include any combination of hardware and software for generating data structures 218 related to electricity consumption. Data structure generator 252 can monitor electricity characteristics 208 and determine or identify the conditions, state or status of electricity distribution (e.g., generation or consumption) on, near or adjacent to one or more sites 119. Data structure generator 252 can be part of the edge devices 250 and can utilize ML models 242 to generate data structures. Data structure generator 252 can ensure that the data received by the data processing system 150 is accurate and in a usable format. For instance, the data structure generator 252 can utilize one or more functions on the edge device 250 for monitoring or measuring electricity characteristics 208 at or near the site 119 of the edge device 250 to gather data. This data (e.g., measurements of voltage, power, current or similar information) can then be reformatted into a format of the data structure 218 to be provided to the coordinator agent 202 or the consumption data monitor 210. The data structure generator 252 can be designed to be compatible with the natural language-based protocol used by the data processing system 150.

ML framework 240, which can also be interchangeably referred to as an AI framework, can include any combination of hardware and software for providing, training, or improving ML models 242 used in the grid management system. The ML framework 240 can utilize various ML functionalities to enhance the performance and accuracy of the ML models 242. The ML framework 240 can include components such as data preprocessing modules, feature extraction tools, and model training algorithms. The ML framework 240 can support supervised, unsupervised, and reinforcement learning techniques to train the ML models 242. The ML framework 240 can incorporate transfer learning and ensemble learning to improve model performance. The framework can be designed to handle large volumes of data collected from edge devices 250 and process it using trained or learned techniques. The ML framework 240 can continuously monitor the performance of the ML models 242 and update the ML models 242 periodically or per identified opportunities or occasions at which the performance can be improved. ML framework 240 can provide tools for hyperparameter tuning and model validation to ensure that the ML models 242 are robust and reliable. The ML framework 240 can support the deployment of ML models 242 in a distributed environment, enabling real-time data processing and decision-making.

ML models 242, which can include, be based on, or be referred to interchangeably as AI models, can include any combination of machine learning algorithms and techniques used to analyze data and generate insights for grid management or operation. ML models 242 can include generative AI models, transformers, and other machine learning techniques configured to provide various functionalities of the data processing system 150 components. For example, generative AI models 242 can be used to generate synthetic data for training purposes, while transformers can be used for natural language processing tasks (e.g., processing NL protocol texts, generating prompts 214, or generating guidance 232). ML models 242 can include supervised learning models such as decision trees, random forests, and support vector machines, which can be used for classification and regression tasks, such as predicting electricity consumption patterns, identifying anomalies in power usage, classifying types of electrical loads, forecasting peak demand periods, and optimizing energy distribution strategies. Unsupervised learning models such as k-means clustering and principal component analysis can be used for data segmentation and dimensionality reduction. Reinforcement learning models can be used to optimize control functions by learning from interactions with the environment. Deep learning models such as convolutional neural networks (CNNs) and recurrent neural networks (RNNs) can be used for image and sequence data analysis, such as detecting anomalies in grid infrastructure images, forecasting electricity consumption trends, analyzing time-series data from smart meters (e.g., edge devices), identifying patterns in energy usage, and predicting equipment failures or constraint breaches, based on historical data. Transfer learning models can leverage pre-trained models to improve performance on specific tasks. Ensemble learning models can combine multiple models to improve accuracy and robustness. ML model 242 can be configured to handle various data types, including time-series data, spatial data, and textual data, ensuring comprehensive analysis and decision-making capabilities. These models can be continuously updated and improved using the AI or ML framework 240 to ensure improved performance and accuracy of the operations in the grid management system.

Data processing system 150 can be utilized by utility engineers or operators. For instance, a utility company can receive a customer call related to potential power-quality issues in homes connected to a specific transformer. To address these concerns, the utility personnel can request an increase in the data resolution from the standard 15-minute interval to a 10-second interval. This high-resolution data can then be sent to the cloud for analysis. Over the course of a week, the collected data can be used to plot aggregate power-quality metrics for the transformer and correlate these metrics with each home's EV charging and photovoltaic (PV) generation activities.

After a week passes by and following reviewing of the plots, the utility personnel can identify periods when one or more of the aggregate power-quality metrics are outside of ANSI bounds. During these periods, the system can determine which homes contribute to 20% of the power-quality issues. For the identified homes, specific volt-var curves can be sent to be used on their PV inverters, and customized EV-charging rates can be applied to their EV chargers. These corrective measures can be implemented if the local power-quality measures, such as voltage, are outside predefined bounds or constraints. The high-resolution sampling can be maintained for all homes under the transformer during this period.

Another week can go by, and the utility personnel again can use the high-resolution data to plot the aggregate power-quality metrics for the transformer and correlate these metrics with each home's EV charging and PV generation activities. Upon reviewing the new plots, it can be observed that the volt-var curves and EV-charging-rate limits have successfully corrected the ANSI violations on the transformer. As a result, the utility company can consider two options, such as: offering the participating homes a discount on their bill to allow for the deployment of custom volt-var curves and EV charging-rate limits, or monitoring the transformer for an additional month to establish a Time-of-Use (ToU) rate that will be offered to all customers under that transformer.

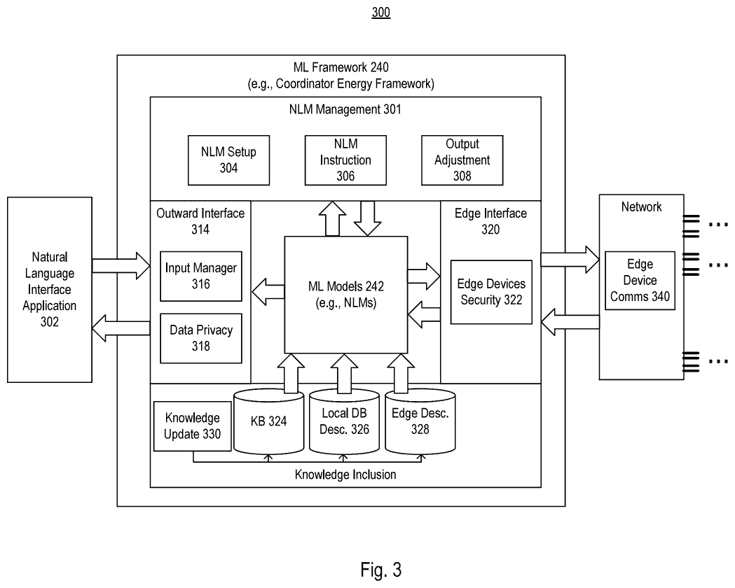

The systems and methods can address the challenges introduced by the construction of a grid-wide data measurement, analysis, and control system. An example structure of the system can be described in conjunction with at least one of FIGS. 3-5 discussed herein.

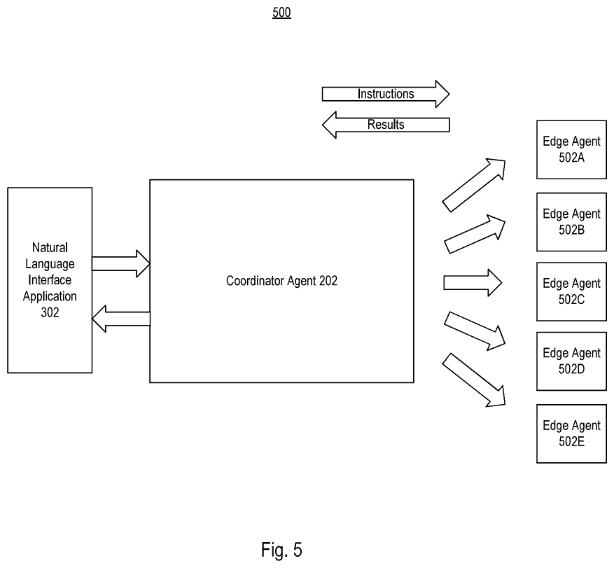

FIG. 3 is a block diagram of an example system 300 having various components of an example ML framework 240, which can also be referred to as a CEF 240, in accordance with an implementation. FIG. 3 can include one or more components similar to those shown in at least FIG. 5. For example, the CEF 240 (e.g., ML framework of a data processing system) can be included within or a part of the data processing system 150. The CEF 240 can correspond to, be coupled with, or be a part of a coordinator agent 202 including or in communication with the natural language interface (NLI) application 302 and one or more edge agents on edge devices 250. The CEF 240 can communicate with the one or more edge agents via the network. The edge agents can be part of or correspond to respective edge devices 250 (e.g., metering devices 118).

To provide safe and high-quality results, the CEF 240 can supply a plurality of capabilities. For example, the CEF 240 can provide application-specific knowledge (e.g., information from at least one of knowledge base (KB) 324, local database (DB) description 326, or edge description 328) to the ML model 242 (e.g., NLM) through or via the knowledge inclusion functions (e.g., knowledge update 330, KB 324, local DB desc. 326 and edge desc. 328). The application-specific knowledge or other information in the database can be updated by an updater (e.g., knowledge update unit or component).

In another example, the CEF 240 can manage the execution of the NLM. In some cases, a relatively frequent amount of work or operation can occur between, for instance, user input (e.g., input from an operator of the data processing system 150) and instruction generation operation, or between the result collection operation and output to the operator (e.g., presenting the result to the operator). The output to the operator may include prompt modification, information retrieval, multiple NLM calls to generate and execute analysis plans, instruction verification or refinement (e.g., sandboxed execution, NLM-based refinement, etc.), or other types of actions or tasks to be performed by at least one of the coordinator agent or the edge agent.

In further examples, the CEF 240 can manage the input and output of the NLM 242. Managing the input and output of the NLM 242 can involve ensuring that the input and the output of the NLM meet or satisfy one or more action (e.g., grid and equipment) constraints, data privacy requirements, or edge-compute limitations, among other criteria.

The knowledge inclusion can be a part of the CEF 240. The knowledge inclusion may sometimes be referred to as information sources of the CEF 240 configured to supply information to at least the NLM 242. The NLM 242 can utilize one or more information sources (from the knowledge inclusion function or component) to inform or structure its outputs (e.g., instructions and natural-language interactions). The information sources can include a KB, a coordinate DB description 326, or an edge description. The KB 324 can be used to understand the contextualized information discussed hereinabove and design analysis to produce answers to user-posed questions or queries, for example. The coordinate DB description 326 can include at least the description of any data sources directly accessible to the coordinator agent (or the data processing system 150). The edge description can include at least the description of at least one of data, one or more action, or one or more capability of the one or more edge agents. In some cases, the KB, coordinate DB description, and edge description can be a part of a single data storage. In some other cases, the KB 324, coordinate DB description 326, and edge description can be separate data storages. The information sources can be improved or expanded over time to incorporate at least one of user or operator feedback, information learned from user interaction, updated or new insights from new data as the new data is measured and stored as well as its processed outputs, etc.

The NLI application 302 can communicate with the outward interface 314 component of the CEF using natural language. The outward interface 314 can include an input management 316 (e.g., sometimes referred to as an input manager 316) configured to obtain or take in natural language requests. The input management 316 can setup or configure the CEF to (properly) process the request. The outward interface 314 can include a data privacy 318 component configured to ensure that the user data is shared or prevented from being shared according to a predefined privacy parameter. The privacy parameters can include, for instance, privacy settings configured by the operator or other predefined security settings.

The NLM management 301 component of the CEF 240 can be configured to provide additional context, instructions, or execution of the NLM. The NLM setup 304 component can setup the NLM. The NLM instruction 306 component can provide (additional) instructions for the NLM. The output adjustment 308 (e.g., output optimization) component can adjust or optimize the NLM output. For example, features of the NLM management 301 component can be performed via adding further inputs to the NLM 242 and utilizing one or more (relatively more-advanced) AI-techniques to optimize the NLM output (e.g., by the output optimization component), such as “reflection” for code improvement, agent planning and problem breakdown, or multiagent approaches, etc. There may be multiple back-and-forth interactions with the NLM to iteratively refine a request or obtain more information.

The knowledge inclusion component of the CEF 240 can provide KB functionalities, definitions of the coordinator DB description 326, and edge DB description 328 to the NLM 242. These components of the knowledge inclusion can provide the NLM (e.g., ML model 242) with the information to analyze, monitor, or control energy data and energy systems, for instance, via writing code and interpreting the results. The information from the sources (e.g., databases of the knowledge inclusion) can flow or be provided to the NLM. In some cases, the data sources can be updated and refined over time by the knowledge update component.

The edge interface 320 component of the CEF 240 can provide at least one interface for sending instructions to or receiving (and storing) results from the edge agents (e.g., edge device comms 340). The NLM 242 can generate instructions or code to analyze results. The outputs (e.g., the analyzed results) can be verified for correctness and security using the edge devices security component (e.g., sometimes referred to as data and device security component), for example. After verification or authentication, the edge interface can send instructions to one or more edge agents. After verification (by the edge agent), the edge agent can generate and execute a code on results for analysis. The resulting analysis can be feedback to the NLM for inclusion in its natural language output.

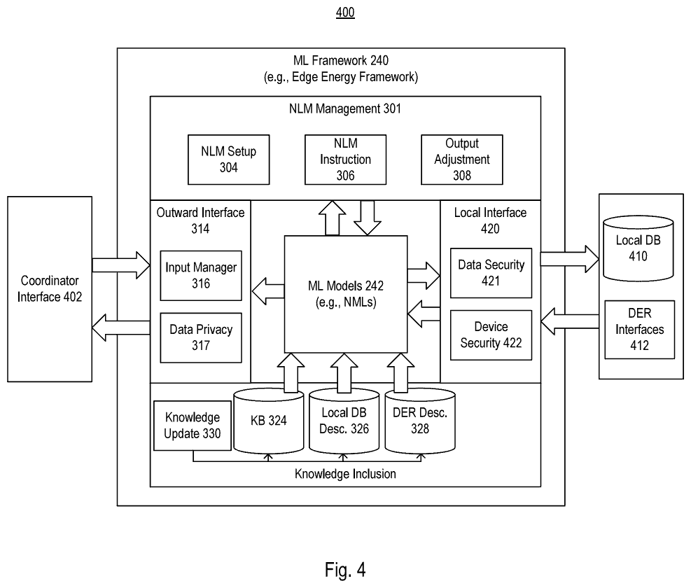

The edge agent 502, further shown in FIG. 5, can include or be communicatively coupled with, one or more structures described in conjunction with at least FIG. 4. One or more structures or functions of the edge agent 502 or associated with edge agent 502, can be similar to those of the coordinator agent 202, such as the one described in connection with FIG. 3. Certain structures or functions may be different between the edge agent 502 and the coordinator agent, such as the input or output, e.g., represented by a coordinator interface 402. For example, FIG. 4 is a block diagram of various components of the ML framework 240 that can be included within, coupled with, or associated with an edge device 250 and can also be referred to as the EEF 240, in accordance with an implementation. The components of the ML framework 240 of the edge agent 502 (e.g., EEF 240 on an edge device 250) can be included within, communicatively coupled with or a part of an edge device 250, such as a metering device 118 located at the site 119 on the grid edge.

The EEF 240 can be in communication with one or more components internal to or external from the metering device 118, such as at least the coordinator interface 402, a local DB 410, and DER interfaces 412. The components of the EEF 240 can include at least an NLM management component, an outward interface, a local interface, and a knowledge inclusion. In some cases, one or more components of the EEF 240 discussed herein may be external from the metering device 118, e.g., features of the one or more components may be executed on the cloud or a remote computing device. It should be noted that the EEF 240 can include or be in communication with other components not limited to those discussed herein.

As shown, the EEF 240 can include or be in communication with the coordinator interface. The coordinator interface 402 can take in instructions from the coordinator agent 202. The coordinator interface 402 can generate results according to the description or schema in the instructions from the coordinator agent 202. In such cases, the functionality provided by other components of the EEF 240 can be specialized to fulfill the objectives (e.g., KB 324 can have a complete understanding of the terminology and intention of the instructions; code verification can ensure that the results data schema satisfy the specification, etc.). The data or signals from at least the coordinator agent or the operator operating the coordinator agent can be provided to the EEF 240 (or the NLM management of the EEF 240) via the outward interface 314.

The EEF 240 can include the outward interface 314. The outward interface 314 can include at least an input management component (e.g., sometimes referred to generally as an input manager 316 or input management) and a data privacy 317 component. The input management can receive the natural language requests from the coordinator interface to set up (e.g., by at least the NLM setup 304) the EEF 240 for proper processing of the request. The data privacy 317 component can ensure that customer (or user) data is secure, e.g., share certain predefined types of data and prevent the sharing of certain other types of data. The types of data restricted from sharing can be predefined by the administrator of the system (e.g., metering device 118) or by the user or consumer. The types of data allowed to be shared can be predefined by the administrator or the user.

The EEF 240 can include the knowledge inclusion component(s). The knowledge inclusion component can provide at least KB functionalities, definitions (or descriptions) of the local DB 326, and the DER functionality, description, or definition to the ML model 242 (e.g., the NLM). The components (e.g., KB 324, local DB description 326, or DER description 328) of the knowledge inclusion component can provide the NLM with the information to support analyzing, monitoring, or controlling energy data and energy systems, e.g., via writing code and interpreting the results. The information for the NLM can flow from the data sources (e.g., KB, local DB description, or DER description) into the NLM 242. The data sources can be updated or refined over time. For example, the knowledge inclusion component can include a knowledge update component configured to update at least one of the data sources. The knowledge update component can provide an update periodically, upon receiving broadcast updates from the cloud, in response to receiving an update request via the coordinator interface (or other interfaces), etc.

The EEF 240 can include the NLM management 301 component. The NLM management 301 component can include one or more components (e.g., NLM setup 304 component, NLM instruction 306 component, output adjustment 308 (e.g., output optimization) component) for providing additional context, instructions, and execution of the ML model 242 (e.g., the NLM). The features of the NLM management 301 component can be executed or performed via a combination of providing additional inputs to the NLM and utilizing one or more AI techniques, also referred to as ML techniques, to adjust or optimize the NLM output, such as a reflection for code improvement, agent planning and problem breakdown, or multiagent approaches. In various scenarios, interaction with the NLM may include or involve one or more interactions or exchanges between the user and the NLM, for instance, to iteratively refine a request, refine the answer, or obtain more information.

For example, the NLM management 301 (e.g., NLM setup 304 component) can provide specificity for the NLM 242, such as adding context to the request, conversation history (e.g., historical requests or inputs), or interpretation of the requests. In some cases, the NLM management (e.g., NLM setup 304 component) may prompt the user for clarification of the request, command, or question via the NLI application. For instance, the NLM management can process the query or request from the user to determine whether to request clarification or add context for setting up the NLM. The NLM management 301 can determine to request clarification if the query is unclear, e.g., question or command is unclear or whether the query is a question or command to be executed. In some cases, the NLM management can communicate with the NLM to process the query for determining to request clarification from the user. For instance, the KB (or other data sources) may include information regarding supported types of actions (e.g., capable of being performed by the EEF 240), types of questions, etc. If the question or query from the user is not sufficiently specific or may be misinterpreted (e.g., interpreted in a plurality of ways), the NLM or the NLM management can generate a question to request more context or clarification. The NLM management 301 can receive feedback or clarification from the user to add context for the NLM to process the query. The NLM management 301 can add context, such as information from the knowledge inclusion component to enhance inputs to the NLM, thereby improving the output from the NLM 242.

The NLM management 301 can include an agent selector (not shown) for selecting a type of agent based on the user input or query. For example, the NLM management 301 (e.g., agent selector) can map the input or query from the user to a type of agent. The NLM management can perform the mapping by at least one of identifying keywords (e.g., rule-based) in the query, asking or prompting the NLM to determine the type of request from the user (e.g., provide the query as an input and receive an indication of a type of agent to use as an output), or executing a machine learning classifier. The types of agent can be predefined, including at least one of but not limited to an analyzing agent (e.g., provide statistics, information, or insights from data), a managing or alerting agent (e.g., alert when energy level is above a predefined threshold), or an action agent (e.g., charge EV to a predefined energy level by a predefined time). The agents of the NLM can handle queries and controls of electrical devices authorized by the user.

The NLM management (e.g., NLM instruction component) can issue or provide instructions to the NLM. The NLM management can control the behavior or function of the NLM according to the query, e.g., processed by the NLM setup component. The NLM management can control the function of the NLM according to the selected agent, such as to perform an analysis, manage alerts, or take actions on loads or DERs at the site. In some cases, the NLM management (e.g., NLM instruction component) can indicate the knowledge (or data) source for the NLM to use. For example, the NLM management 301 can indicate to the NLM to use information from a particular knowledge source (e.g., background energy information). The NLM management may provide information on the type of data collected at the site (or types of data collected by the edge devices) to the NLM. The NLM management 301 can provide the description of the devices (e.g., DERs) that the agent can control to the NLM, e.g., EV charger, power storage, thermostat, etc. The devices capable of being controlled by the EEF 240 can be configured by the user via registration and authorization. The EEF 240 can create instructions specific to the controllable DERs.

The output optimization of the NLM management 301 can refine or adapt the output from the NLM or other components of the EEF 240 for clarification to the user. In some cases, the user may prompt the NLM to clarify the output via the coordinator interface (or other application interfaces). In such cases, the output optimization can allow for an ability to orchestrate the NLM (e.g., call the NLM more than once for a request) for clarification, thereby obtaining the desired output from the NLM. In some cases, the output optimization can evaluate the quality of the output, such as determining whether the output corresponds to the command issued by the user, relevancy of the output to the query or request (e.g., requested information and type of information outputted), etc.

The EEF 240 can include the local interface 420. The local interface can provide programmatic interfaces into the local DB and the DER interfaces 412. The local DB can include, store, or maintain information collected or processed by the system (e.g., the metering device 118 or the metering platform). The DER interfaces can allow for communication with the DERs. The ML model 242 (e.g., the NLM) can generate code to access these functions. The code can be verified for correctness and security using at least one of the data security 421 component or the device security 422 component. The code can be executed to access the local DB, for example. The results from executing the code or accessing the local DB can be fed back to the NLM for inclusion in the natural language output.

In some configurations, the data security component of the local interface can verify that the local DB is being accessed according to predefined security criteria or rules (e.g., staying within the rules). The device security component can enforce the constraints or limits of devices on the site, such that commands or outputs to the controllable devices (e.g., DERs or loads) allow the devices to operate with the operational constraints (e.g., physical-based constraints on local voltage, regulated by the utility). The rules or constraints can be predefined by the administrator or utility operator. For example, the constraints can include voltage or current limits, maximum frequency for turning on or off the EV charger, predefined limit of devices to be controlled within a time period, etc.

In some cases, the NLM can generate a code for the local interface, for instance, to access the local DB or control devices, among other features or functionalities. The NLM can utilize existing function calls or create new code to control one or more authorized devices (e.g., DERs or loads). The EEF 240 (e.g., device security component) can verify the code before execution. For example, the device security component can put a synthetic device call to test the code execution or execute the generated code in a simulation before deployment. The device security component can initiate a virtual environment to test the generated code before executing the code to control an actual device. The result of the simulation can be used as feedback for improving the code (e.g., to obtain different or improved results).

In some cases, code generated (e.g., verified codes) by other metering devices 118 within the utility grid 100 can be uploaded to the cloud and downloaded by or shared to individual metering devices 118. In some other cases, the generated code or feedback to the code can be uploaded to the cloud for training or tuning a centralized NLM over time. The centralized NLM can be broadcasted or downloaded to the EEF 240 of one or more metering devices 118, for example. The device security component can bind one or more devices (e.g., DERs) to a predefined set of parameters for security purposes and depending on the utility parameters. In certain scenarios, such as when utilizing existing code or generating codes similar to existing codes, the device security component may determine to skip the simulation, thereby verifying the code for execution.

For verified codes, the local interface 420 can execute the function or code to access the local DB 410 or control one or more DERs via the DER interfaces 412 (e.g., edge solution). The output of executed function can be fed or sent back to the NLM. The NLM 242 can generate a result for presentation to the user, e.g., the result can include human-readable information, including texts, graphs, audio, statistics, etc. Examples of the results can include electricity consumption at a certain time period, prediction of electrical consumption, prediction of electric bill, an indication of completed (or failed) tasks, graphs showing information on the trend of electricity usage, etc. The format for presenting the results can be predefined or configured by the user. In some cases, the user can provide a query or input indicating the format to display the result or generated data.

The local DB 410 can store at least one of operational data from the local controllable devices (e.g., flexible or controllable loads or DERs), an information-rich dataset obtained from statistical signal processing, or physics or machine-learning-based models operating on the raw, local electrical metering signals. The local DB 410 can support storing relatively large amounts of relevant historical data, for instance, to provide low latency for communication and decision-making and allow for access to relatively large amounts of historical data which may not be feasible (e.g., consume extensive resources) to send to the cloud. Storing data in the local DB 410 can provide user privacy as sensitive data is maintained locally at the site of the measurement, reduce resource consumption by minimizing data transmission to the cloud, and minimize latency by using the locally stored data.

The EEF 240 can encapsulate the various elements or components discussed herein, including but not limited to at least one of the NLM 242, KB 324, or local DB 410. The EEF 240 can utilize the KB and the local DB to provide application-specific knowledge to the NLM. The EEF 240 can manage the input, execution, or output of the NLM to ensure proper inputs are used and desired outputs are obtained, e.g., providing safe and high-quality results for controlling the loads or DERs. For example, the EEF 240 can provide application-specific knowledge to the NLM via at least one of the KB 324 (e.g., including general and proprietary information relevant to electric distribution, analysis of electricity and energy data, or equipment knowledge), the definition of local data (e.g., sometimes referred to as local data definition or description) being measured or produced and how to interpret and analyze the local data, the definition (or description) of the available DER actions and the potential results of the actions, or prompting instructions or other NLM inputs to assist in guiding the NLM to high-quality (desired) outcomes or outputs.

In various implementations, the coordinator instruction specifications and edge agent 502 capabilities can evolve in parallel, increasing in capability, precision, and reducing resource usage over time. This flexibility can be possible due to the ability of NLMs 242 to generate and interpret flexible instructions instead of being constrained to a fixed, pre-defined schema. With such flexibility, the systems and methods can allow for individualized or personalized actions to be performed at the edge devices.

The systems and methods of the technical solution discussed herein can provide various improvements or advantages, including flexibility for supporting grid-wide data analysis results combining a wide variety of edge configurations. For example, there may be a variety of DER energy devices attached to each edge node (e.g., metering device 118), and a variety of energy consuming devices. The coordinator agent does not require knowledge regarding the variety of DER energy devices or energy consuming devices, or how to handle it. For instance, instead of requiring the knowledge on the varieties, the coordinator agent can distribute at least one instruction to a plurality of edge agents 502, such that the customization of the edge analysis or control can be performed by each edge agent using information via the knowledge inclusion (e.g., from sources, such as the KB 324, local DB 410, and DER descriptions 328). Because knowledge regarding the variety of DER energy devices or energy consuming devices is not required, resources can be minimized (e.g., minimize information transmission from the edge devices regarding the DER energy devices or energy consuming devices, hence, reducing information to be stored) and complexity can be reduced.

Further, the systems and methods can provide flexibility for a variety of grid-wide analysis and control requests through natural-language specification. For instance, the systems and methods does not require knowledge of a complete range of requests, or pre-implementation of the range of requests, because the coordinator agent and edge agent (or node) can be capable of generating the instructions or code to fulfill the requests. In some cases, the systems and methods can provide data locality. The data analysis and controls interactions can be executed or performed by the edge agent 502, thereby minimizing data transfer (e.g., reducing resources) and providing a platform where data privacy and security can be managed by avoiding the transfer of sensitive data. In some configurations, the systems and methods can implement a traditional decentralized system design based on static schemas or protocols, not limited to the type of implementations discussed herein to perform the features or functionalities of the coordinator agent or the edge agents 502, for example.

FIG. 5 shows an example high-level structure (e.g., a coordinator agent and edge agent structure) of a system 500 addressing the challenges of constructing the grid-wide data measurement, analysis, and control system. As shown, the system 500 can include at least one coordinator agent, at least one NLI application 302, and a plurality of edge agents 502A-502E. At least one of the coordinator agents 202, the NLI application 302, or the edge agent 502 can be composed of hardware, software, or a combination of hardware and software components. For purposes of providing examples, the coordinator agent 202 can correspond to or be a part of the data processing system 150 and each edge agent 502 can correspond to or be a part of a respective metering device 118 (e.g., edge device 250). It should be noted that each edge agent 502 may include features or functionalities similar to or different from other edge agents 502A-502E. One or more features or functionalities of the edge agent(s) can be performed or executed by the coordinator agent.

The coordinator agent 202 can include, or be coupled with, a data processing system 150 and be configured to perform a centralized role (e.g., any role of the data processing system 150), including at least one of but not limited to sending one or more requests, providing instructions or commands, or receiving results (e.g., measurement or analysis results) from one or more edge agents. Each edge agent 502A-E can be located at the grid edge (e.g., a residential home or at a site). The coordinator agent 202 can be remote from the edge agent(s). In some cases, the coordinator agent may be one of the edge agents 502 configured to perform the centralized role, for example.

The coordinator agent 202 can be a point-of-contact with the grid-operator representatives, for instance, providing natural-language interactions and showing data analysis results and reports. For example, the data processing system 150 (e.g., coordinator agent) can include a display device configured to present a user interface (UI) or a graphical user interface (GUI). The UI can provide a visual representation of the results or reports from the data analysis performed by at least one of the coordinator agents or one or more of the edge agents. The UI can provide interactive elements for the operator to interact with (e.g., enter queries, select actions, or initiate an operation) via an input device, such as a keyboard, microphone (e.g., voice command), mouse, touchscreen, etc. In some cases, the UI can be physical buttons interactable by the operator. The coordinator agent 202 can provide other types of UI or perform other operations not limited to those discussed herein.

In various configurations, the data processing and analysis techniques may not be predetermined or may not be specified or configured in advance. Instead, the data processing and analysis techniques can be generated or determined dynamically. The data processing operations, e.g., greater than half or a majority of the data processing operations, can occur at the edge, such as by the edge device (e.g., metering device 118). Executing the data processing operations at the edge (instead of the server) can reduce data transfer and network traffic and minimize privacy and security risks.

The system 500 can include a natural-language, interactive, grid-scale platform having a plurality of features. One of the features can include a centralized coordinator agent. The coordinator agent can be housed in a data center, a cloud, a server, or other devices remote from the edge devices. For purposes of providing examples, the coordinator agent can be housed or included as part of the data processing system 150. The coordinator agent 202 can be coupled with, or implemented as, a ML model 242, such as a NLM (e.g., a generative pre-trained transformer) embedded or implemented in a CEF of FIG. 3 or EEF of FIG. 4. The CEF or EEF can utilize multiple techniques discussed herein to coordinate tasks for multiple edge agents 502, for instance, to perform at least one of analysis, create monitors or alerts, or take one or more actions.

Another one of the features can include the coordinator agent generating the one or more tasks for the edge agents. The coordinator agent can specify or indicate the task(s) as instructions, e.g., requirement-level description of the expected or desired processing, actions, or return data (e.g., results) for the edge agents to implement. The instructions may not be a code. The instructions may contain data schemas, algorithm descriptions, implementation details, or other criteria to produce or generate a code. The instructions may be generated dynamically in response to a request, such that predefined data schemas or algorithms are not required. In such cases, the coordinator agent can provide instructions to one or more edge devices or edge agents to generate at least one code to perform one or more tasks.

At least one of the features can include a set of edge agents. The edge agents 502 can be coupled with, or implemented as, ML models 242, such as NLMs embedded in one or more EEFs of FIG. 4. Each edge agent can exist at a grid endpoint (e.g., residences or businesses). The grid endpoint can refer to the grid edge. The edge agent 502 can support or be capable of receiving and following (e.g., executing) the instructions from the coordinator agent. One or more edge agents can receive instructions different from one or more other edge agents. In some cases, the edge agents in a first set of edge agents can receive similar instructions from the coordinator agent. Different sets of edge agents (or different groups of edge agents) may receive similar or different instructions from the coordinator agent. The edge agent can obtain measurements, process edge data, or return the processed data as results to the coordinator agent. The edge agent may execute or take one or more actions, for instance, based on the results of processing the data.

In some cases, as part of the features, the coordinator agent and the edge agent can embed an NLM within a framework (e.g., CEF or EEF) that transforms the framework into an energy-domain expert, able to utilize relevant knowledge (e.g., related background information) as necessary to analyze the energy data (e.g., electricity data). Based on the analysis, the NLM can command or control one or more (available) devices and monitor one or more capabilities. The one or more capabilities can exist at a relatively higher level for the coordinator agent (e.g., generating the instructions) and at a relatively lower level for the edge agent (e.g., generating code that satisfy the instructions).

At least one other feature of the plurality of features can include an NLI application. The NLI application can be within or a part of the coordinator agent. In some cases, the NLI application can be a part of a different device from the coordinator agent, configured to communicate with the coordinator agent. The NLI application can be a basis for an interaction with the platform discussed herein. The system 500 can include other features not limited to the plurality of features discussed hereinabove.

At least a part of the system 500 can include or contain extensions of the NLI for an electric-metering platform. For instance, the CEF can include one or more features, structures, or functions similar to the EEF. The CEF and EEF may include certain differences, such as at least one of the concepts of a hierarchical analysis framework, the introduction of dynamically generated instructions, one or more abilities of the edge agent, or the extensions of the coordinator energy framework.

For example, the concept of a hierarchical analysis framework can allow for natural-language description of distributed analysis, monitoring, or one or more action tasks from a centralized location. In some cases, the action task can include tasks that have not previously been conceived, e.g., non-predetermined actions or new tasks. The instructions can be generated dynamically (instead of predefined or preset instructions), leveraging the capabilities of NLMs to generate, interpret, or execute the instructions. The edge agents can locally execute the instructions (received from the coordinator agent) without transmitting the data being analyzed to the coordinator agent or other remote devices. The edge agents can execute local actions according to the analysis or processed data. Operating the edge agents locally can reduce data transmission overhead, reduce network resources, or maintain data privacy. In further examples, features of the CEF can be extended to allow for planning of analysis tasks over a relatively large number of distributed endpoints, which may involve additional planning capabilities and an understanding of the larger grid structure or operational characteristics.

In various configurations, utilizing the NLMs embedded within the CEF at the coordinator level (e.g., for coordinating task(s) for the edge agents) can involve facilitating human-like interaction with the platform and generating one or more responses that may be unique to the requests made during the interaction. In some cases, the NLMs embedded within the CEF can be utilized to generate instructions comprising a desired level or amount of specificity (e.g., sufficiently well-specified) for the edge agent to interpret and generate detailed results for the coordinator agent. For instance, the NLM can generate instructions including at least one of data schemas, algorithm descriptions, or implementation details, among other parameters, to generate a code. If the instructions lack certain (e.g., desired or required) parameters or amount of parameters, the coordinator agent may not send the instructions to the edge agents, e.g., the results from the analysis by the edge agents according to these instructions may not satisfy the desired level of details. Otherwise, if the instructions include a desired level of specificity, the coordinator agent can send the instructions to the edge agent(s) to perform an analysis or process data at the edge. The coordinator agent can utilize a relatively more powerful NLM compared to the edge agents. The coordinator agent can consider the capabilities and limitations of the edge agents when generating the instructions.

In combination, the generated information can be customizable and accessible, and the model can be relatively more powerful compared to a library lookup (e.g., which is limited in its combination of stored information due to the explicit or predefined format of the library lookup). The NLM 242 can be trained on at least one of but not limited to contextualized information relevant to the electrical grid, grid-edge measurements, or equipment capabilities. The training data or information used to train the NLM 242 can be supplied by the CEF. For example, the training data can include at least one of an estimate of the electrical grid configuration with respect to equipment and edge nodes, engineering descriptions of reliability and resilience issues, techniques for detection (e.g., how the issues can be detected), measurement, modeling, forecasting, the electricity tariffs of the utility grid 100, descriptions of data available at the one or more edge nodes to be analyzed, or descriptions of other sensors or measurement points on the grid, additionally or alternatively to the edge devices (e.g., metering devices 118).

In some configurations, the coordinator agent can be configured to detect or predict peaks, e.g., spikes of electrical consumption across the grid, according to information or data from the edge agents. The coordinator agent can interact with or provide instructions to one or more edge agents to reduce or minimize the spike or curve at the predicted timeframe, e.g., by at least one of adjusting tap settings, adjusting thermostats (based on authorization), reducing EV charging events, etc. In some cases, the coordinator agent may request the energy consumption prediction from the edge agent to determine an action to initiate, for instance, to reduce the electrical consumption curve or spike, among other actions. The coordinator agent can request other types of information from the edge agent, satisfying privacy or security parameters. As discussed herein, the coordinator agent can generate instructions for the edge device (e.g., edge agent) to generate a code to perform at least one task according to the instructions.

For example, the coordinator agent can generate a first instruction requesting predictions from one or more edge agents. The instruction may indicate the data format or criteria for returning the data (from edge agents), e.g., table format, frequency to provide the data (e.g., every 5 minutes), etc. The coordinator agent can utilize the NLM to dynamically build the protocol. The NLM 242 can determine the types of information to be obtained by accessing the knowledge base or other sources of information discussed herein.

In further examples, the coordinator agent can generate a second instruction to aggregate or add predictions from the edge agents. The aggregated predictions can be utilized to determine the electrical consumption curve, indicative of the predicted electrical consumption over a time period of the prediction, such as 1 hour, 2 hours, 12 hours, 1 day, etc. The coordinator agent may generate a third instruction to cause one or more edge devices (associated with the edge agents) to take at least one action, for instance, to reduce the potential curve, such as reducing electrical consumption during the peak electrical consumption time.

In some cases, edge-to-edge device communication can be implemented. For instance, the coordinator agent can generate subgroups of edge agents. Each subgroup can include one or more edge agents. The coordinator agent can instruct each subgroup to optimize electrical consumption amongst itself based on the predicted electrical consumption. In some cases, if at least one edge device detects an event or alert (e.g., storms, fault detection, etc.), the edge agent of the edge device can inform other edge devices within the subgroup (e.g., including edge agents within a similar geographical location or associated with the same secondary transformer), such that an action can be initiated to remedy the event or minimize damage caused by the event.

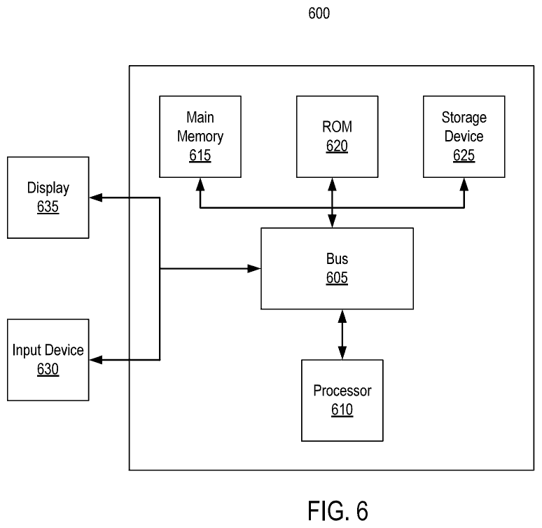

FIG. 6 is a block diagram of an example computer system 600. The computer system or computing device 600 can include or be used to implement the data processing system 150, edge device 250 or a metering device 118, or any of their components. The computing system 600 includes at least one bus 605 or other communication components for communicating information and at least one processor 610 or processing circuit coupled to the bus 605 for processing information. The computing system 600 can also include one or more processors 610 or processing circuits coupled to the bus for processing information. The computing system 600 also includes at least one main memory 615, such as a random access memory (RAM) or other dynamic storage devices, coupled to the bus 605 for storing information, and instructions to be executed by the processor 610. The main memory 615 can also be used for storing position information, utility grid data, command instructions, device status information, environmental information within or external to the utility grid, information on characteristics of electricity, or other information during execution of instructions by the processor 610. The computing system 600 may further include at least one read only memory (ROM) 620 or other static storage device coupled to the bus 605 for storing static information and instructions for the processor 610. A storage device 625, such as a solid state device, magnetic disk or optical disk, can be coupled to the bus 605 to persistently store information and instructions.

The computing system 600 may be coupled via the bus 605 to a display 635, such as a liquid crystal display, or active matrix display, for displaying information to a user such as an administrator of the data processing system or the utility grid. An input device 630, such as a keyboard or voice interface may be coupled to the bus 605 for communicating information and commands to the processor 610. The input device 560 can include a touch screen display 635. The input device 630 can also include a cursor control, such as a mouse, a trackball, or cursor direction keys, for communicating direction information and command selections to the processor 610 and for controlling cursor movement on the display 635. The display 635 can be part of the data processing system 150, the edge device 250 or a metering device 118, or any other components of at least one of FIGS. 1-5.

The processes, systems, and methods described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. Hard-wired circuitry can be used in place of or in combination with software instructions together with the systems and methods described herein. Systems and methods described herein are not limited to any specific combination of hardware circuitry and software.

Although an example computing system has been described in FIG. 6, the subject matter including the operations described in this specification can be implemented in other types of digital electronic circuitry, or in computer software, firmware, or hardware, including the structures disclosed in this specification and their structural equivalents, or in combinations of one or more of them.

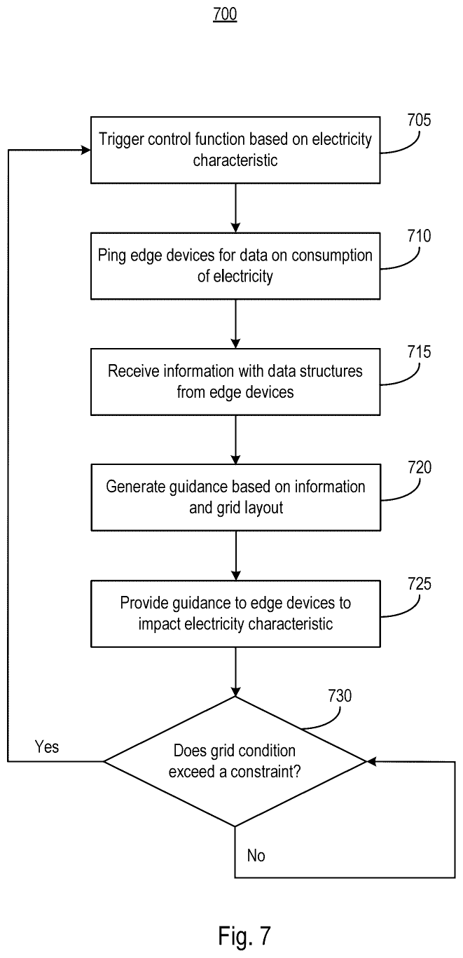

FIG. 7 illustrates an example flow diagram of a method 700 for providing grid-scale natural-language-interactive analysis monitoring and control platform. Example method 700 can be executed or implemented by a data processing system, which can be provided or implemented at a device (e.g., a physical or a virtual server or a cloud-based service) that is remote from a plurality of edge devices that are located or deployed at a plurality of sites in an electricity distribution grid. The data processing system can be provided or executed using one or more processors (e.g., 610) of the grid edge device executing instructions and data stored in memory (e.g., 615) of the remote device (e.g., server). The method 700 can be implemented using any combination of any features and functionalities described in connection with FIGS. 1-6 implementing acts 705-730. At 705, the method can include triggering a control function based on one or more electricity characteristics. At 710, the method can include pinging one or more edge devices on the electricity distribution grid to receive data on consumption of electricity. At 715, the method can receive, from the edge devices, information having data structures. At 720, the method can include generating guidance to impact the electricity characteristic, based on the received information and a layout of the electricity distribution grid. At 725, the method can include transmitting the guidance to the edge devices to impact the electricity characteristic. At 730, the method can monitor if the grid condition exceeds a constraint.

At 705, the method can include triggering a control function based on one or more electricity characteristics. The method can include one or more processors of a data processing system triggering a control function based on a characteristic of electricity related to the electricity distribution grid. The data processing system can be located remote from a plurality of edge devices that are located at or near a plurality of sites on an electricity distribution grid. The control function can include a function configured to establish or implement one or more operations on the electricity grid to adjust the performance of the electricity grid by addressing or impacting one or more electricity characteristics (e.g., voltage, current, power consumption, power generation, load, frequency, phase angle, power factor, and energy usage) of any or more portions of the electricity grid, including one or more sites associated with one or more edge devices.

The method can include detect a peak in demand of electricity on the electricity distribution grid. The peak in demand of electricity can be associated with a time duration or a time interval. The peak can include an amount of electricity that exceeds a threshold for acceptable amount of electricity demand during the time period. The data processing system can utilize a function trigger that can be configured to trigger a control function to adjust, reduce or flatten the electricity demand. The function trigger can select a control function configured for flattening or reducing electricity demand from a plurality of control functions configured for a plurality of operations. The function trigger can select the control function based on the detected peak in demand of electricity or based on a type of a plurality of types of control functions.

Data processing system can select, from a plurality of control functions, a particular control function to address a particular electricity characteristic or address a particular constraint detected at the grid. The control functions can be classified or categorized based on their operations and objectives. For example, a control function can be a control function for a peak demand management, which can be configured to flatten peak electricity demand by reducing power consumption during high-demand periods. For example, a control function can be a function that is load shedding, which can be configured to temporarily turning off or reduce power that is low priority or unused in order to prevent grid overloads. For example, a control function can be a function for energy storage management and can be configured to adjust charging and discharging cycles of energy storage systems to balance supply and demand. For example, a control function can be a demand response control function, configured to adjust the power consumption of flexible loads based on real-time electricity prices or grid conditions, encouraging energy usage during off-peak times. For example, a control function can be a renewable energy integration control functions to manage the incorporation of renewable energy sources, such as solar or wind, into the grid by adjusting the output of conventional power plants to maintain stability. For example, a voltage regulation can be a function to control or adjust voltage levels across the grid to ensure a stable and consistent electricity supply, preventing voltage fluctuations and improving power quality. The control functions can be triggered based on detection of one or more electricity characteristics exceeding their respective thresholds or constraints (e.g., exceeded a recommended voltage, current or power level, load level or power factor) with respect to any portion of the grid, including any of the sites associated with or coupled with any edge devices.

At 710, the method can include pinging one or more edge devices on the electricity distribution grid to receive data on consumption of electricity. The method can include the data processing system pinging the plurality of edge devices for data related to consumption of electricity via the electricity distribution grid. The data processing system can ping the edge devices using a natural language-based protocol compatible with a generative machine learning model. The natural language-based protocol can be constructed according to one or more rules or regulations or can be constructed dynamically, such as on-the-fly and using the generative machine learning model. The natural language-based protocol can be constructed based on a knowledge base related to the electricity distribution grid. The knowledge base can include information or data on the electricity grid and its components.

The method can include the data processing system, prior to triggering the control function, pinging the plurality of edge devices for a prediction related to consumption of electricity over a time interval. The prediction can involve a forecast of electricity demand, electricity consumption, power, voltage or current levels or prediction of any electrical characteristic over a time interval. The method can include the data processing system detecting a peak in demand of electricity during the time interval based on receipt of the prediction responsive to the ping. The data processing system can trigger the control function (e.g., a selected control function) responsive to detection of the peak in the demand during the time interval. The method can include pinging, prior to triggering the control function, the plurality of edge devices for a prediction related to consumption of electricity over a time interval.

The method can include the data processing system constructing, using the natural language-based protocol, a prompt. The prompt can define a format for the information to be generated by the plurality of edge devices. The prompt can include instructions or data defining or describing the format. The format can be used by the edge devices to generate the requested information on the consumption or delivery of electricity from the one or more edge devices. The data processing system can transmit or ping the plurality of edge devices using the prompt, for instance based on the prompt or using the prompt.

The method can include the data processing system determining, based on the information, to perform a second ping of the plurality of edge devices, prior to the generation of the guidance. The second ping can be performed using the natural language-based protocol. The second ping can request a second information, such as an information on a second one or more electricity characteristics that are different than the first one or more electricity characteristics requested in the prior ping. The second ping can request information or data from a different one or more edge devices than the one or more edge devices of the prior ping.

The method can include generating, based on the information and the layout of the electricity distribution grid, and responsive to the trigger of the control function, a preliminary guidance configured to impact consumption of electricity at the plurality of sites. The method can include constructing construct, using the natural language-based protocol, a prompt comprising the preliminary guidance and a request for second information related to consumption of electricity in accordance with the preliminary guidance. The method can include the data processing system transmitting the prompt (e.g., comprising the preliminary guidance and the request for second information) to the plurality of edge devices. The method can include transmitting, to the one or more edge devices, a prompt constructed using the natural language-based protocol.

At 715, the method can receive, from the edge devices, information having data structures. The method can include the data processing system receiving, from the plurality of edge devices, information in response to the ping. The information can include one or more data structures generated via the generative machine learning model executed by each of the plurality of edge devices. For instance, the information can include one or more data structures from each one of the one or more edge devices pinged at act 710. For instance, the data structures from each of the edge devices can be generated by the edge devices using one or more ML models. The edge devices can each generate their own one or more data structures, responsive to the ping or the prompt from the data processing system. The data structures from each of the edge devices can include information on the state or condition or electricity generation or consumption at the sites corresponding to the respective edge device. The data structures can include information or data, such as measurements of various timestamped or time interval based electricity characteristics. The data structures can include information on conditions or constraints on the grid that can trigger one or more control functions to be initiated or utilized at 705.

The method can include the data processing system receiving the information in accordance with the format defined in the prompt that was constructed using the natural language-based protocol. The format can include a form of the information generated by the edge devices. The method can include receiving, from the plurality of edge devices, second information responsive to the second ping performed using the natural language-based protocol prior to generation of the guidance. The method can include generating the guidance based on the second information and receiving the information (e.g., including data structures of the edge devices) in response to the plurality of edge devices executing the generated processor-executable instructions to perform the quantitative analysis in accordance with the prompt.

The method can include data processing system receiving, from the plurality of edge devices, preliminary information in response to the prompt comprising the preliminary guidance. The method can include the data processing system determining, based on the preliminary information, that the preliminary guidance satisfies a condition related to the characteristic of electricity. The condition can include a threshold value of an electricity characteristic, such as a threshold corresponding to voltage, current or power.

At 720, the method can include generating guidance to impact the electricity characteristic, based on the received information and a layout of the electricity distribution grid. The method can include the data processing system generating, based on the information (e.g., data structures from one or more edge devices) and a layout of the electricity distribution grid, guidance configured to impact the characteristic of electricity at the plurality of sites. The data processing system can generate the guidance responsive to the trigger of the control function. The guidance can include instructions, descriptions, rules or guidelines to maintain one or more electricity characteristics (e.g., values or measurements of voltage, current, power consumption, power generation, load, frequency, phase angle, power factor, or energy usage) at any of the sites or monitored by any of the edge devices, within particular range or within particular threshold for such electricity characteristics and for particular time intervals.

The method can include generating the guidance based on the second information received from the plurality of edge devices responsive to the second ping. The method can include generating the guidance, responsive to the determination that the preliminary guidance satisfies the condition related to the characteristic of electricity or based on the preliminary guidance. The method can include the data processing system generating, based on the information and the layout of the electricity distribution grid, responsive to the trigger of the control function, preliminary guidance configured to impact consumption of electricity at the plurality of sites.

The method can include the data processing system constructing, using the natural language-based protocol, a prompt comprising the preliminary guidance and a request for second information related to consumption of electricity in accordance with the preliminary guidance. The method can include the data processing system transmitting the prompt to the plurality of edge devices. The method can include the data processing system receiving, from the plurality of edge devices, preliminary information in response to the prompt comprising the preliminary guidance.

The method can include the data processing system determining, based on the preliminary information, that the preliminary guidance from the prompt does not satisfy a condition related to the characteristic of electricity (e.g., a threshold value for an electricity characteristic). The method can include the data processing system generating, responsive to the determination that the preliminary guidance does not satisfy a condition, a second prompt with second preliminary guidance. The method can include the data processing system generating the guidance responsive to second information or responsive to the second prompt satisfying the condition related to the characteristic of electricity.

The method can include the data processing system determining, based on a type of control function, to generate a prompt related to quantitative analysis. The knowledge base can include a topology of the electricity distribution grid. The topology of the electricity distribution grid can include elements of the grid (e.g., devices or hardware) and relationships between the elements, defining the topology of the grid. The method can include the data processing system generating the guidance (e.g., instructions or commands to address the electricity characteristic issue) using or based on the topology or layout of the grid input into one or more ML models. The method can include the data processing system generating the guidance in accordance with a constraint established for the electricity distribution grid.

At 725, the method can include transmitting the guidance to the edge devices to impact the electricity characteristic. The method can include the transmit, to the plurality of edge devices, the guidance to impact the characteristic of electricity at the plurality of sites. The method can include the coordinator agent or the consumption data monitor of the coordinator agent transmitting the guidance to a particular edge device or to one or more edge devices. The receiving edge device or the one or more edge devices can utilize the guidance to operate, control or adjust operation of one or more devices at the site or adjacent to the site to affect, impact or change the electricity distribution to adjust or change the electricity characteristic (e.g., place the electricity characteristic within a tolerance or threshold range of operation as dictated or identified by the guidance).

The method can include the data processing system transmitting, to the one or more edge devices, a prompt constructed using the natural language-based protocol. The prompt can include preliminary guidance and the request for second information (e.g., additional one or more data structures from one or more edge devices) on consumption of electricity in accordance with the preliminary guidance. The preliminary guidance can include rules, parameters or thresholds, or ranges of thresholds for electricity characteristics (e.g., same or different electricity characteristics as measured or asked about in the initial ping). The electricity characteristics can be associated with a time period and preliminary guidance can dictate or identify electricity characteristics within a set threshold range. The updated or second information (e.g., second data structures) can provide information in connection with one or more edge devices in accordance with the preliminary guidance to generate updated guidance for the edge devices.

The data processing system can determine, based on a type of control function, to generate a prompt related to quantitative analysis. The data processing system can transmit the prompt related to quantitative analysis to the plurality of edge devices to cause the plurality of edge devices to generate, using the generative machine learning model executed by the plurality of edge devices, processor-executable instructions to perform the quantitative analysis in accordance with the prompt.

At 730, the method can monitor if the grid condition exceeds a constraint. The method can include the one or more edge devices or the data processing system monitoring the operational conditions of the electricity distribution (e.g., electricity characteristics) at the grid for instances in which the electricity distribution exceeds predetermined constraints or thresholds. For instance, edge devices can periodically monitor the status of any one or more electricity characteristics (e.g., at, near or adjacent to their respective sites), including for example levels of voltage, current, power consumption, power generation, load, frequency, phase angle, power factor, or energy usage, which can be compared against constraints or thresholds. For instance, edge devices can periodically generate and transmit to the data processing system the updated electricity characteristics. The data processing system can determine if the electricity characteristics indicate a grid condition in which the grid exceeds a constraint. For instance, the data processing system can receive from an edge device a determination determined by the edge device that the grid condition constraint is exceeded.

For instance, the method can include the data processing system detecting a peak in demand of electricity on the electricity distribution grid. The data processing system can trigger, or determine to trigger, based on the detection of the peak, the control function to flatten the demand. For instance, the method can include the data processing system pinging, prior to triggering the control function, the plurality of edge devices for a prediction related to consumption of electricity over a time interval. The method can include detecting a peak in demand of electricity during the time interval based on receipt of the prediction responsive to the ping. Some of the descriptions herein emphasize the structural independence of the aspects of the system components (e.g., arbitration component) and illustrate one grouping of operations and responsibilities of these system components. Other groupings that execute similar overall operations are understood to be within the scope of the present application. Modules can be implemented in hardware or as computer instructions on a non-transient computer-readable storage medium, and modules can be distributed across various hardware- or computer-based components.

The method can determine whether the electricity distribution conditions (e.g., grid conditions) exceed a condition or operate within predetermined or acceptable range for various electricity characteristics. In the event that the determination is made that the grid condition does exceed a constraint, the method can go to act 705 to trigger a control function (e.g., for that specific constraint) based on the electricity characteristic. In the event that the determination is made that the grid condition does not exceed a constraint, the method can include the edge devices or data processing system continuing to monitor the grid operation to identify any changes in the operation.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., a field programmable gate array (FPGA) or an application specific integrated circuit (ASIC). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC. Devices suitable for storing computer program instructions and data can include non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and digital versatile disk read-only memory (DVD-ROM) disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a LAN and a WAN, an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

While this specification contains many specific implementation details, these should not be construed as limitations on the scope of any inventions or of what can be claimed, but rather as descriptions of features specific to particular embodiments of particular aspects. Certain features described in this specification in the context of separate embodiments can also be implemented in combination in a single embodiment. Conversely, various features described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated in a single software product or packaged into multiple software products.

Thus, particular embodiments of the subject matter have been described. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A system, comprising:
a data processing system, comprising one or more processors coupled with memory, located remote from a plurality of edge devices located at a plurality of sites in an electricity distribution grid, the data processing system to:
trigger, based on a characteristic of electricity related to the electricity distribution grid, a control function;
ping, using a natural language-based protocol compatible with a generative machine learning model, the plurality of edge devices for data related to consumption of electricity via the electricity distribution grid;
receive, from the plurality of edge devices, information in response to the ping, the information comprising one or more data structures generated via the generative machine learning model executed by each of the plurality of edge devices;
generate, based on the information and a layout of the electricity distribution grid, responsive to the trigger of the control function, guidance configured to impact the characteristic of electricity at the plurality of sites; and
transmit, to the plurality of edge devices, the guidance to impact the characteristic of electricity at the plurality of sites.

2. The system of claim 1, wherein the data processing system is further configured to:
detect a peak in demand of electricity on the electricity distribution grid; and
trigger, based on the detection of the peak, the control function to flatten the demand.

3. The system of claim 1, wherein the data processing system is further configured to:
ping, prior to triggering the control function, the plurality of edge devices for a prediction related to consumption of electricity over a time interval;
detect a peak in demand of electricity during the time interval based on receipt of the prediction responsive to the ping; and
trigger the control function responsive to detection of the peak in the demand during the time interval.

4. The system of claim 1, wherein the data processing system is further configured to:
construct, using the natural language-based protocol, a prompt defining a format for the information generated by the plurality of edge devices;
ping the plurality of edge devices using the prompt; and
receive the information in accordance with the format defined in the prompt.

5. The system of claim 1, wherein the data processing system is further configured to:
determine, based on the information, to perform a second ping, using the natural language-based protocol, of the plurality of edge devices prior to generation of the guidance;
receive, from the plurality of edge devices, second information responsive to the second ping; and
generate the guidance based on the second information.

6. The system of claim 1, wherein the data processing system is further configured to:
generate, based on the information and the layout of the electricity distribution grid, responsive to the trigger of the control function, preliminary guidance configured to impact consumption of electricity at the plurality of sites;
construct, using the natural language-based protocol, a prompt comprising the preliminary guidance and a request for second information related to consumption of electricity in accordance with the preliminary guidance;
transmit the prompt to the plurality of edge devices;
receive, from the plurality of edge devices, preliminary information in response to the prompt comprising the preliminary guidance;
determine, based on the preliminary information, that the preliminary guidance satisfies a condition related to the characteristic of electricity; and
generate, responsive to the determination, the guidance based on the preliminary guidance.

7. The system of claim 1, wherein the data processing system is further configured to:
generate, based on the information and the layout of the electricity distribution grid, responsive to the trigger of the control function, preliminary guidance configured to impact consumption of electricity at the plurality of sites;
construct, using the natural language-based protocol, a prompt comprising the preliminary guidance and a request for second information related to consumption of electricity in accordance with the preliminary guidance;
transmit the prompt to the plurality of edge devices;
receive, from the plurality of edge devices, preliminary information in response to the prompt comprising the preliminary guidance; and
determine, based on the preliminary information, that the preliminary guidance does not satisfy a condition related to the characteristic of electricity.

8. The system of claim 7, wherein the data processing system is further configured to:
generate, responsive to the determination, a second prompt with second preliminary guidance; and
generate the guidance responsive to second information responsive to the second prompt satisfying the condition related to the characteristic of electricity.

9. The system of claim 1, wherein the data processing system is further configured to:
determine, based on a type of control function, to generate a prompt related to quantitative analysis; and
transmit the prompt related to quantitative analysis to the plurality of edge devices to cause the plurality of edge devices to generate, using the generative machine learning model executed by the plurality of edge devices, processor-executable instructions to perform the quantitative analysis in accordance with the prompt.

10. The system of claim 9, wherein the data processing system is further configured to:
receive the information in response to the plurality of edge devices executing the generated processor-executable instructions to perform the quantitative analysis in accordance with the prompt.

11. The system of claim 1, wherein the natural language-based protocol is constructed dynamically on-the-fly using the generative machine learning model and a knowledge base related to the electricity distribution grid.

12. The system of claim 11, wherein the knowledge base comprises a topology of the electricity distribution grid.

13. The system of claim 1, wherein the data processing system is further configured to:
generate the guidance in accordance with a constraint established for the electricity distribution grid.

14. A method, comprising:
triggering, by a data processing system, comprising one or more processors coupled with memory, based on a characteristic of electricity related to an electricity distribution grid, a control function, wherein the data processing system is located remote from a plurality of edge devices located at a plurality of sites in the electricity distribution grid;
pinging, by the data processing system, using a natural language-based protocol compatible with a generative machine learning model, the plurality of edge devices for data related to consumption of electricity via the electricity distribution grid;
receiving, by the data processing system, from the plurality of edge devices, information in response to the ping, the information comprising a data structure generated via the generative machine learning model executed by each of the plurality of edge devices;
generating, by the data processing system, based on the information and a layout of the electricity distribution grid, responsive to the trigger of the control function, guidance configured to impact the characteristic of electricity at the plurality of sites; and
transmitting, by the data processing system, to the plurality of edge devices, the guidance to impact the characteristic of electricity at the plurality of sites.

15. The method of claim 14, comprising:
detecting, by the data processing system, a peak in demand of electricity on the electricity distribution grid; and
triggering, by the data processing system, based on identification of the peak, the control function to flatten the demand.

16. The method of claim 14, comprising:
pinging, by the data processing system, prior to triggering the control function, the plurality of edge devices for a prediction related to consumption of electricity over a time interval;
detecting, by the data processing system, a peak in demand of electricity during the time interval based on receipt of responses responsive to the ping; and
triggering, by the data processing system, the control function responsive to detection of the peak in the demand during the time interval.

17. The method of claim 14, comprising:
constructing, by the data processing system, using the natural language-based protocol, a prompt defining a format for the information generated by the plurality of edge devices;
pinging, by the data processing system, the plurality of edge devices using the prompt; and
receiving, by the data processing system, the information in accordance with the format defined in the prompt.

18. The method of claim 14, comprising;
determining, by the data processing system, based on the information, to perform a second ping, using the natural language-based protocol, of the plurality of edge devices prior to generation of the guidance;
receiving, by the data processing system, from the plurality of edge devices, second information responsive to the second ping; and
generating, by the data processing system, the guidance based on the second information.

19. The method of claim 14, comprising;
generating, by the data processing system, based on the information and a layout of the electricity distribution grid, responsive to the trigger of the control function, preliminary guidance configured to impact consumption of electricity at the plurality of sites;
constructing, by the data processing system, using the natural language-based protocol, a prompt comprising the preliminary guidance and a request for second information related to consumption of electricity in accordance with the preliminary guidance;
transmitting, by the data processing system, the prompt to the plurality of edge devices;
receiving, by the data processing system, from the plurality of edge devices, preliminary information in response to the prompt comprising the preliminary guidance;
determining, by the data processing system, based on the preliminary information, that the preliminary guidance satisfies a condition related to the characteristic of electricity; and
generating, by the data processing system, responsive to the determination, the guidance based on the preliminary guidance.

20. A non-transitory computer-readable storage medium storing processor-executable instructions that, when executed by one or more processors, cause the one or more processors to:
trigger, based on a characteristic of electricity related to the electricity distribution grid, a control function;
ping, using a natural language-based protocol compatible with a generative machine learning model, a plurality of edge devices for data related to consumption of electricity via an electricity distribution grid, the one or more processors located remote from the plurality of edge devices located at a plurality of sites in the electricity distribution grid;
receive, from the plurality of edge devices, information in response to the ping, the information comprising a data structure generated via the generative machine learning model executed by each of the plurality of edge devices;
generate, based on the information and a layout of the electricity distribution grid, responsive to the trigger of the control function, guidance configured to impact the characteristic of electricity at the plurality of sites; and
transmit, to the plurality of edge devices, the guidance to impact the characteristic of electricity at the plurality of sites.
